(19) United States
(12) Patent Application Publication
(10) Pub. No.: US 2026/0156328 A1
(43) Pub. Date: Jun. 4, 2026

(54) SYSTEMS AND METHODS FOR SYNCHRONIZING SUPPLEMENTAL EXTENDED REALITY (XR) MEDIA CONTENT

(71) Applicant: Adeia Guides Inc., San Jose, CA (US)

(72) Inventors: Charles Dasher, Lawrenceville, GA (US); Mathew Adams, Matthews, NC (US)

(21) Appl. No.: 18/968,572

(22) Filed: Dec. 4, 2024

(51) Int. Cl. H04N 21/81; G06T 7/579; G06T 7/60; G06T 7/73; H04N 21/414; H04N 21/4223; H04N 21/43; H04N 21/485

(52) U.S. Cl. CPC H04N 21/8133; G06T 7/579; G06T 7/60; G06T 7/73; H04N 21/41407; H04N 21/4223; H04N 21/43079; H04N 21/485; G06T 2207/30204

(57) ABSTRACT

The present application provides for synchronizing supplemental extended reality (XR) media content with media content on a primary device. A media server may stream media content on a client device and then receive a request to provide XR content supplementing the media content. The media server may then transmit to the XR device (a) an image of a visual marker for determining dimensions and a location of the client device displaying the media content, and (b) timing information. The media server may then transmit to the client device instructions to display the visual marker at a time that is based on the timing information. The XR device may then capture an image of the client device at the time that is based on the timing information and determine the dimensions and the location, and then display the XR content supplementing the media content based on the determined dimensions and location.

### BACKGROUND

This disclosure is related to systems and methods for synchronizing media content, an in particular to synchronizing media content in extended reality (XR) applications.

### SUMMARY

With the emergence of XR and the increasing importance of use of XR to interact with media content, there is an increasing need to augment media content with XR environments. XR is an umbrella term referring to virtual reality (VR), mixed or merged reality (MR), augmented reality (AR), or some combination thereof. Media systems commonly deliver media content, such as movies and episodes of a series, via streaming, or over-the-top (OTT), content platforms. Such platforms may offer content items for consumption in a variety of different formats, for example standard definition, high definition and ultra-high definition. The systems that provide XR experiences may offer user interface to interact with content items, or augment content items, using interfaces similar to those for controlling media streams. However, providing relevant data for synchronization with the media content and the XR supplemental content remains a difficult task.

In one approach, a system provides XR supplemental content (e.g., AI-generated content) based on metadata associated with primary media content (e.g., content shown on a traditional television screen). However, this approach is deficient in synchronizing the XR supplemental content with the media content because there is no temporal element associated with the XR supplemental content that directly corresponds to a specific temporal element of the media content. For example, if a system streams a movie (e.g., “Jurassic Park”), the XR supplemental content may be determined to be an XR image of a T-Rex. Although the XR T-Rex is related to Jurassic Park, it is not specifically related to a timestamp within the movie itself.

In another approach, a system provides supplemental XR content that overlaps the line of sight to the media content, which detracts from the viewing experience. This system is deficient in being unable to determine the specific geometric position of the XR device relative to a non-XR client device that is providing the content (e.g., a television). Because of this deficiency, the XR supplemental content may be superimposed on top of the line of sight to the non-XR client device. Moreover, this problem is exacerbated by the XR device moving, which would require an entirely new calibration of the location and dimensions of the client device, as the XR device is now in a new position. For example, when a viewer with AR glasses is sitting on a couch to watching a movie on a television, the viewer will naturally change their posture on the couch. By changing their posture, the required spatial data of the AR glasses relative to the television is different than it was previously. The system does not recognize this, and the XR supplemental content does not adjust for the new position.

To solve these problems, systems and methods are provided herein for synchronizing supplemental extended reality (XR) media content with media content on a primary device. In some embodiments, a media server may stream media content on a client device. For example, the media server streams the movie “Moana” to a television. The media server may receive a request to provide XR content supplementing the media content. Continuing with the example above, a request is received, through a user-interface from an XR headset, requesting XR content supplementing Moana. The media server may then transmit to the XR device (a) an image of a visual marker for determining dimensions and a location of the client device displaying the media content, and (b) timing information. Continuing with the example above, the media server may transmit an image of an oar from Moana to be placed at each corner of the television at 1:08 hr into the movie. The visual marker may be associated with metadata of the media content (e.g., the visual marker may be an oar from the movie Moana that is playing on the client device).

The media server may transmit to the client device instructions to display the visual marker at a time that is based on the timing information (e.g., display the Moana oars at 1:08 runtime). The XR device may then capture an image of the client device at the time that is based on the timing information and determine the dimensions and the location. Continuing with the example above, the media server may determine that the XR device is 10 feet away with an angle of 43° to the x-axis plane of the television. The media server may then display the XR content supplementing the media content based on the determined dimensions and location. Continuing with the example above, the media server may determine the distance of the XR device to the client device and determine what modifications to the XR content need to be applied, apply those modifications, and displays, with the modifications, the XR content.

In some embodiments, the visual marker is generated at a fixed size regardless of a size of a display of the client device (e.g., absolute size of the television). The media server may determine a simultaneous localization and mapping (SLAM) data of an environment and the location of the client device in relation to the XR device based on the visual marker. For example, based on four oars being positioned at the corners of the television, the XR device may determine the relative locational mapping between the XR device and the television. This may also be used in a movie theater application where the SLAM data for a particular seat may be shared from one XR device to another XR device that utilizes that same seat for a different show.

In some embodiments, once SLAM data is generated, the XR device may receive and generate XR experiences designed specifically for the media content (e.g., an immersive XR overlay for the room related to the Moana movie). The SLAM data may be used by the XR device to show XR content in a way that avoids obstructing the screen of the primary device.

Optionally, major pieces of furniture may also remain unobstructed. Advantageously, the full SLAM data describing the environment can be used by the XR device to adjust the XR display based on movements of the headset without the need for radiation calibration. In some embodiments, the XR content is designed specifically for supplementing the media content. In such approaches, the XR content is synchronized with playing of the media content (e.g., via timestamp cues in the XR content stream and in the media stream).

The SLAM data can be transmitted to and used by other devices, without the need for additional calibration of such devices. For example, in a movie theater environment, variants of SLAM data may be computed and associated with each seat. When an XR device becomes associated with the seat (e.g., via a ticket purchase), that device may be provided with an appropriate SLAM data variant for showing XR content for supplementing the movie.

By providing synchronization for XR media content that supplements the non-XR media content, multiple XR devices may enjoy XR content that is synchronized to the movements of the XR devices (e.g., AR glasses) relative to the client device (e.g., television).

Because the specific location and dimensions of the client device are known, the media server effectively makes real-time adjustments to the XR content to maximize the experience of immersion in the media content.

In some embodiments, the media server may receive a request to display the XR content for an additional XR device. If the XR device is a primary device (e.g., an administrator, or device that has parental authority over other XR devices), then a UI prompt is generated requesting approval for authorization of the XR content. If granted, instructions are transmitted to the additional XR device to display the XR content. In some variants, there is also a level of access that is authorized or approved by the primary device that may include (a) an option to allow access to the XR content, (b) an option to disallow access to the XR content, and (c) an option to allow partial access to the XR content. For example, an AR glasses device being used by a parent may provide partial access to the XR content for an additional AR glasses device belonging to their child.

In this way the primary device can be used to manage XR experiences of others in the same room. For example, the system may allow the primary device to turn on or off XR experiences for other devices and/or manage the intensity of XR experiences of other devices. In some embodiments, the primary device can manage delivery of XR data to other devices (e.g., from the backend or in peer-to-peer manner) providing bandwidth saving to the system. For example, once the XR data for providing the XR content is downloaded to the primary XR device, the XR device can provide the XR content (to authorized devices) via a local network, alleviating the need for extra streams from an external server.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1A shows an illustrative scenario in which the media server transmits instructions to a client device and an XR device, in accordance with some embodiments of this disclosure.

FIG. 1B shows an illustrative scenario in which an XR device generates SLAM data with multiple other XR devices, in accordance with some embodiments of this disclosure.

FIG. 1C shows an illustrative scenario in which the media server generates XR content supplementing the media content, in accordance with some embodiments of this disclosure.

FIG. 2 shows an illustrative scenario in which visual markers appear on the display of the client device, in accordance with some embodiments of this disclosure.

FIG. 3 shows an illustrative scenario in which a media server calculates an absolute size of a client device, in accordance with some embodiments of this disclosure.

FIG. 4 shows an illustrative scenario in which an XR device determines SLAM data of a theater environment, in accordance with some embodiments of this disclosure.

FIG. 5 shows an illustrative scenario in which an XR device determines SLAM data of a theater environment from multiple locations, in accordance with some embodiments of this disclosure.

FIG. 6 shows an illustrative scenario in which a user interface on the client device displays an option for supplemental XR content, in accordance with some embodiments of this disclosure.

FIG. 7 shows an illustrative scenario in which another user interface on the client device displays options for supplemental XR content, in accordance with some embodiments of this disclosure.

FIG. 8 shows an illustrative scenario in which yet another user interface on the client device displays multiple options for supplemental XR content, in accordance with some embodiments of this disclosure.

FIG. 9 is a sequence diagram of a detailed illustrative process for displaying the visual marker at a time that is based on timing information, in accordance with some embodiments of this disclosure.

FIG. 10 is a sequence diagram of a detailed illustrative process for displaying XR content based on SLAM data, in accordance with some embodiments of this disclosure.

FIG. 11 is a sequence diagram of a detailed illustrative process for implementing synchronization mechanisms to align the timing of the visual marker display with the media content playback, in accordance with some embodiments of this disclosure.

FIG. 12 is a sequence diagram of a detailed illustrative process for a backend service connecting to a third-party content delivery system, in accordance with some embodiments of this disclosure.

FIG. 13 is a sequence diagram of a detailed illustrative process for the backend service re-enabling the XR content for an XR device, in accordance with some embodiments of this disclosure.

FIG. 14 is a sequence diagram of a detailed illustrative process for adjusting the level of XR immersion according to a preference, in accordance with some embodiments of this disclosure.

FIG. 15 shows illustrative user equipment devices, in accordance with some embodiments of this disclosure.

FIG. 16 shows illustrative systems, in accordance with some embodiments of this disclosure.

FIG. 17 is a flowchart of a detailed illustrative process for displaying XR content supplementing the media content based on the determined dimensions and the location of the client device displaying the media content, in accordance with some embodiments of this disclosure.

FIG. 18 is a flowchart of a detailed illustrative process for generating for display a user interface element for selecting a level of access to the XR content for the additional XR device, in accordance with some embodiments of this disclosure.

### DETAILED DESCRIPTION

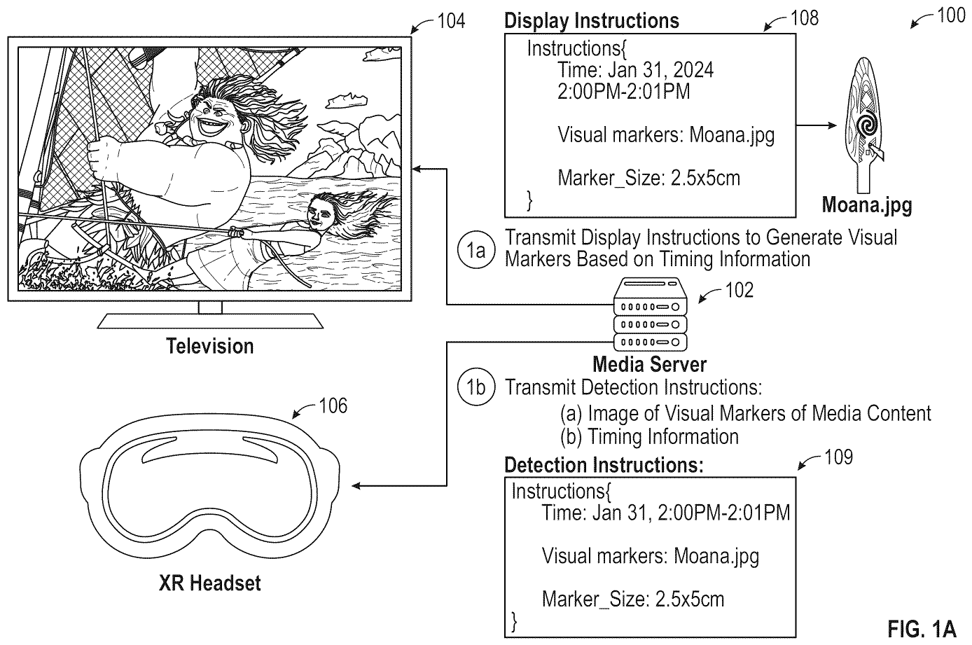

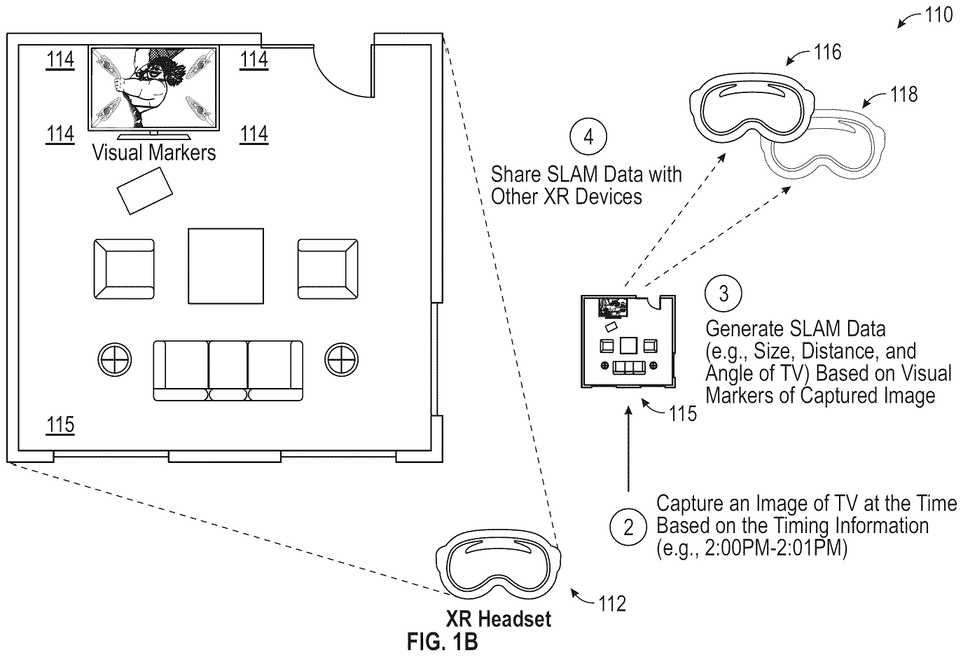

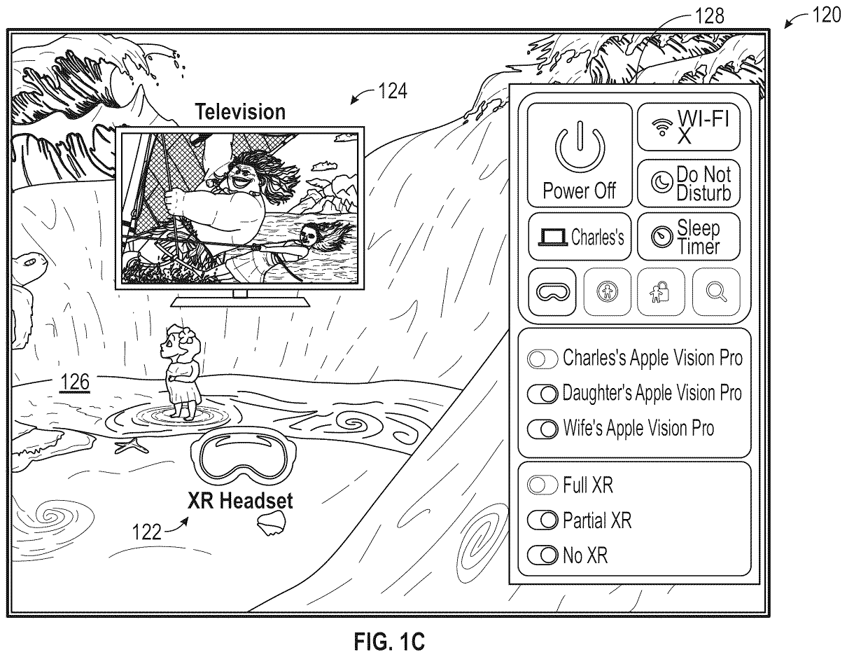

FIG. 1A shows an illustrative scenario 100 in which the media server 102 transmits instructions to a client device 104 and an XR device 106, in accordance with some embodiments of this disclosure. The media server 102 may receive a request to provide XR content supplementing the media content. A media server may be any device that has processing capability and connectivity to a communications network that facilitates transmission of media content and supplements the implementation of XR content. In some embodiments, the media server may provide a stream of media content on a client device. The media server may operate as a backend service provider (e.g., a media hardware module that facilitates media content distribution). The media server enables the association of an XR device with specific media content, such as a channel, series, or user profile, on a client device (e.g., streaming device). This association is facilitated through a backend service that maintains a database of XR devices and their corresponding media content associations. The backend service can manage associations at multiple levels, including global content types (e.g., all content from a specific streaming service), specific channels, individual shows or series, and user profiles that dictate personalized settings and preferences.

In some embodiments, the database is dynamically updated based on user interactions and device registrations, allowing for a flexible and scalable system that accommodates various content delivery configurations. In FIG. 1A, the media server 102 provides a stream of a movie, Moana, to a client device television 104. In other embodiments, a backend service may provide the stream of the media content (e.g., Moana) to the client device. The media server 102 may receive a request to provide XR content supplementing the media content. Continuing with the example above, the media server 102 may receive the request from an XR headset 106 to provide XR content for Moana. In other embodiments, the media server may receive the request from the client device 104 via a user interface selection to provide XR content for Moana. In other embodiments, the media server 102 may receive the request from any electronic device that can interface with the media server (e.g., a smartphone, tablet, smart appliance, smart home device, or similar type device with connectivity). This may include multiple XR devices logging on to the same streaming service providing the media content on client device 104. In this embodiment, the media server 102, or backend service, may register the multiple XR devices with the same streaming service account that is providing media content on client device 104.

In some embodiments, the media server 102 may transmit to an XR device (a) an image of a visual marker for determining dimensions and a location of the client device displaying the media content, and (b) timing information. The visual marker may be any suitable visual image (e.g., a geometric shape, a visual image, a symbol, a pattern, or any type of visual indicator).

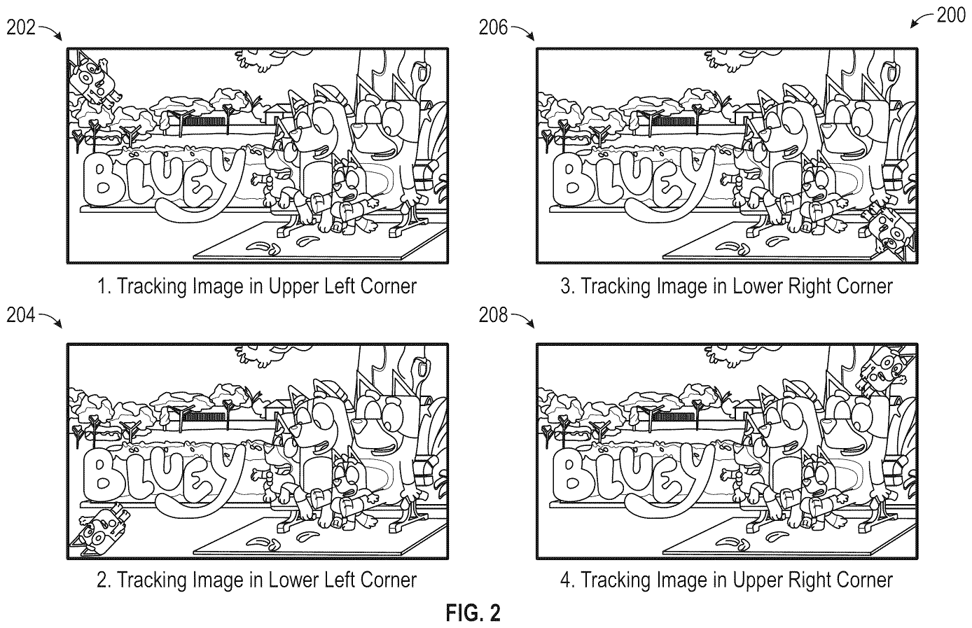

The visual marker may be placed at any part of the dimensions of the client device that defines the dimensions of the client device. For example, on a rectangular television, the visual markers may be placed at each of the corners of the rectangle such that the locations of each of the four corners defines the dimensions of the client device. The media server may transmit the location of the client device via raw data that may be based on the Cartesian coordinate system, and/or pitch, yaw, and roll parameters. In some embodiments, the media server may transmit the location to the client device, where the location may use other spatial data systems (e.g., Wi-Fi positioning systems, LiDAR data, indoor mapping systems, and similar type systems). The timing information may be any type of timing information related to the media content that may include timestamps. Continuing with the example in FIG. 1A, at step 1b, the media server 102 transmits detection instructions to the XR headset that include the image of the visual marker of the media content (e.g., named “Moana.jpg”) and the timing information (e.g., 2:00PM-2:01PM on Jan 31, 2024). For example, the visual marker size may be specified to be 2.5×5cm (or any other suitable specified size and/or shape). In some embodiments, the detection instructions may be implemented via JavaScript Object Notation (JSON), Extensible Markup Language (XML), or any other code/implementation that can define data between devices. FIG. 2 shows an illustrative scenario 200 in which visual markers appear on the display of the client device, in accordance with some embodiments of this disclosure. At 202, a Bluey™ visual marker appears in the top left corner of the display of the television client device (e.g., similar to the television client device with visual markers shown in FIG. 1B at 114). In similar fashion, at 204, a Bluey visual marker appears in the bottom left corner of the display of the television client device. In similar fashion, at 206, a Bluey visual marker appears in the lower right corner of the display of the television client device. In similar fashion, at 208, a Bluey visual marker appears in the upper right corner of the display of the television client device. In some embodiments, the visual marker is displayed in the specified size (e.g., 2.5×5cm) regardless of the size of the screen of the client device.

In some embodiments, the XR device 106 may access metadata associated with the media content. For example, the media server may determine the media content being played in Bluey and access the metadata associated with Bluey. The media server may then generate for display the image for the visual marker based at least in part on the metadata. In other embodiments, the media server (e.g., functioning as the backend service) may access the metadata associated with the media content and generate for display the image for the visual marker based at least in part on the metadata. Continuing with this example, as shown in FIG. 2, an image of Bluey the puppy visual icon is retrieved to be used at the visual marker based on metadata associated with Bluey. In some embodiments, the media server may generate for display a plurality of visual markers that are positioned at each respective corner of a display of the client device. For example, as shown in FIG. 1B, the Moana oars are positioned at each of the four corners of the television client device display at 114 to effectively demarcate the display from the rest of the environment 115. The media server may generate for display the visual markers dynamically and include the relevant information needed for the XR device 112 to validate its participation in the experience. The visual marker may encode the identifiers of the authorized XR devices, session keys, or a combination of both, using formats such as QR codes, data matrix codes, or another machine-readable visual encoding method. The encoded data can be encrypted or obfuscated to prevent unauthorized access or tampering. In some embodiments, the media server may implement AI techniques to generate a visual marker based on the media content. For example, a generative AI used to generate images may be used with inputs that relate to keywords of the media content (e.g., if the media content is Moana, the keywords that are shared may be oar, beach, water, island, and similar themed terms). Many other types of inputs may be used such as metadata, keywords, images, dialogue converted to text, and other associated data to the media content.

In some embodiments, the media server may transmit to the client device instructions to generate for display the visual marker at a time that is based on the timing information. For example, the media server may generate instructions via JSON/XML that provide timing information (e.g., a specific timestamp, a relative timestamp to another timing event such as the start or completion of the media content, or a periodic timer that acts on an interval basis from a defined starting point). Continuing with the example above, in FIG. 1A, at step la, the media server transmits display instructions 108 to the television 104 to generate visual markers based on timing information. Step 1a and 1b within FIG. 1A may occur in any order. This may include step la occurring before, after, or at the same time as step 1b. The instructions include a specific image (e.g., Moana.jpg) which is an oar image from the movie Moana. The media server 102 may have generated the instructions to have included the Moana.jpg oar based on metadata of the media content where the oar was a frequently used symbol throughout the media content. There are also size parameters, e.g., 2.5×5 cm, and timing parameters, e.g., 2:00PM-2:01PM on Jan. 31, 2024. In some embodiments, the media server may transmit instructions to generate the visual marker at a fixed size regardless of the size of a display of the client device. The instructions may also include the specific locations where the visual markers are to be located within the determined dimensions of the client device such that the client device display area can be defined. Continuing with the example above, the media server 102 may provide display instructions 108 that may place the visual markers in the four corners of the display area for client device 104. As stated above, this can be seen in FIG. 1B at 114.

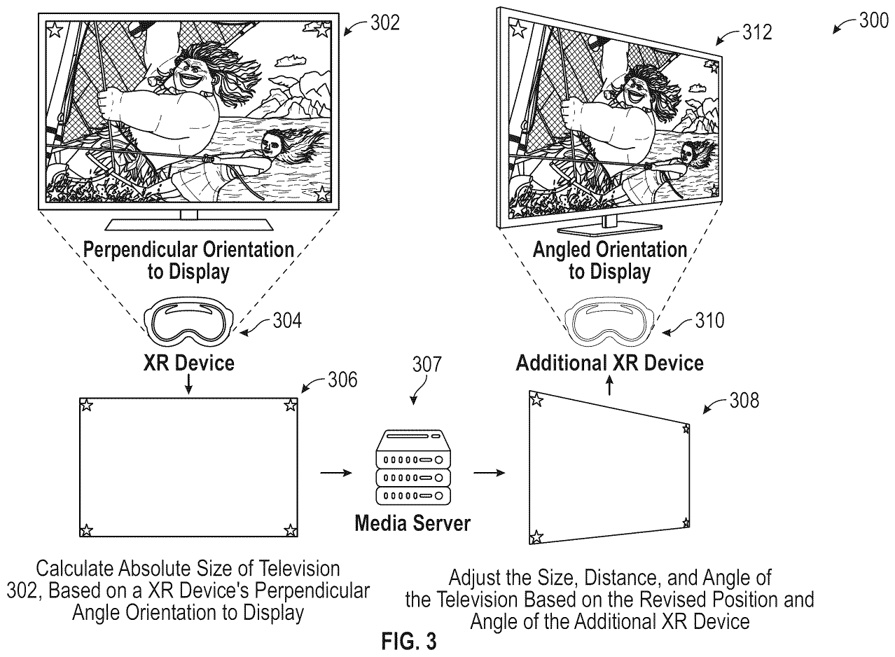

FIG. 3 shows an illustrative scenario 300 in which a media server 307 calculates an absolute size of a client device 302, in accordance with some embodiments of this disclosure.

The XR device at 304 has a perpendicular orientation to the television display 302. This captured data may be utilized to determine the dimensions and the location of the client device 302 in relation to the XR device 304 based at least in part on the visual marker. This is referred to as absolute size, as the XR device observes the television from its vantage point. However, this can be contrasted to the additional XR device 310, which has an angled orientation to the television display 312. Accordingly, the additional XR devices use the absolute size captured at 306, and adjust based on the specific angle, distance, and size of the angled viewing of the additional XR device 310 relative to the XR device 312 (e.g., similar to FIG. 1B where the media server 102 generates SLAM data of the captured image of the XR device based on the visual markers 114 to determine size, distance and angle of the television). Mathematical operations and geometric schema may be implemented by control circuitry of the media server to determine the specific dimensions and the location of the client device in relation to the XR device based at least in part on the visual markers. For example, trigonometry laws may allow for the determination of the aspect ratio of the display size and using other geometric formulas to transpose imagery to fit a different Cartesian plane for display. For example, the media server may calculate width and height of the television display 312 from television 302, by implementing the following method: using the Pythagorean theorem to determine the square of the diagonal is equal to the sum of the squares of the width and height. Let (W) be the width and (H) be the height. For a 16:9 aspect ratio, the width is 16:9 times the height. Substitute the width into the Pythagorean theorem: Replace (W) with (16:9*H) in the equation. To solve for (H), simplify the equation to find the height. The terms can then be combined to result in a single equation. (H) may then be isolated to solve the equation. Once you have (H), multiply it by (16:9) to find the width. This process helps you find the width and height of a screen given its diagonal measurement and a 16:9. Once the width and height are determined, the media server may determine the angled dimension by determining if the TV is tilted at an angle (\theta) from the vertical. Trigonometry may be used to find the new dimensions. In particular, the new width (W′) and new height (H′) can be found using W′=W\cos(\theta)+H\sin(\theta) and new height H′=H\cos(\theta)−W\sin(\theta).

In some embodiments, the media server may determine the size of the display of the client device by receiving the size of the display from a user of the XR device and/or a user of the client device. In some embodiments, the media server may receive the size of the display via a user interface (e.g., a field that requests a numerical value of the screen size, or a selection from a prepopulated set of screen sizes). For example, in FIG. 1A, the media server 102 may receive the size of the display from transmitted data from television 104.

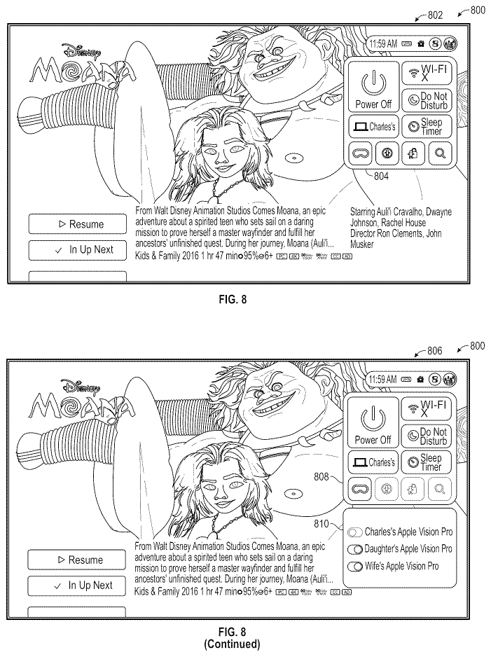

In some embodiments, the media server may receive data regarding the size of the display of the client device from the client device. For example, the client device (e.g., a smart television) may transmit the model number of the smart television to the media server, such that the media server may retrieve the corresponding display size from a database populated with information related to a plurality of client device models. In other embodiments, the media server may receive the size of the display via a user interface from the client device (e.g., a field that requests a numerical value of the screen size, or a selection from a prepopulated set of screen sizes). The user interface may be similar to the user interface shown in FIG. 8 where the client device provides options to interface with the media server and XR device. The media server may transmit the data relating to the size of the client device to the XR device. The XR device may capture an image of the client device in the environment and determine the dimensions and the location of the client device in relation to the XR device based at least in part on the visual marker and based on the received size of the client device based on the aforementioned mathematical operations mentioned in previous paragraphs.

In some embodiments, the media server may receive the model of the client device and determine the size of the display by retrieving publicly available information regarding the model of the client device. For example, the media server may access a database that includes specifications of various types of client devices. In other embodiments, if the model number is known, the media server may determine how many pixels are in the display (e.g., 1920×1080 pixels) and determine an absolute size of the pixels that are extrapolated to the size of the client device. The media device may determine from one of more sources (e.g., a database of model information) the pixel size of the client device. For example, if the media server determines that there are 1920×1080 pixels, and pixel size is 0.0295 in², then the absolute size may be calculated to determine a 65″ screen with 56.7″×31.9″ length and width. In some embodiments, the computed absolute size of the screen can be used by the XR device to validate SLAM calculation (describe above and below) that describe location of the physical space (e.g., client device, environment, and the user). For example, the XR device may re-calibrate the SLAM data if there is a mismatch between TV size determined using SLAM techniques and using the technique describe herein for computing the size of the TV screen. In some embodiments, the display size data may be permanently stored by the XR device and/or by a backend server, such that it can be used as aid data for future AR and/or SLAM calculations by the XR device or by other XR devices. For example, the server can report that data to additional XR device (e.g., after authorization by the primary XR device).

In some embodiments, the client device may transmit the data relating to the size of the client device directly to the XR device in a peer-to-peer configuration over a communications network (e.g., WLAN, or NFC such as Bluetooth). For example, the client device displays the visual marker on the display. The client device may then transmit data to the XR device (or to the media server) that the visual marker (e.g., Moana Oar) is being displayed at an actual size of 0.5″. The XR device may then utilize the data of the visual marker to determine the distance from the client device display screen based on mathematical operations as described above.

In some embodiments, the media server may determine the size of the client device display based on the size of the visual markers relative to the content being displayed on the client device. The ratio of the visual marker to the content being displayed may be used to determine the actual size of the client device. For example, if the visual marker is 0.5″ actual size, and the pixel size of the client device is known (e.g., 0.0295″), then one can determine that the visual marker represents approximately 17 pixels. From this, the media server may extrapolate to determine the size of the client device using the mathematical operations described above.

In some embodiments, the XR device is configured to capture an image of the client device at the time that is based on the timing information. The XR device and the media server need to define the physical environment that the XR device is in so that the XR device knows what surfaces are available for rendering on and where to define the surface of the primary media source display. The media server may use visual markers and utilize the XR device's visual tracking capabilities to identify these visual markers that would be placed anywhere along the dimensions of the client device that allows the XR device to define the physical location of the display of the client device (e.g., a television). For example, the visual markers may be placed along the corners of a display area, along the circumference, along the parameter, or along each determined segment of a display area that may define a geometric shape of the display area.

Along with the XR device's ability to do spatial mapping, the XR device can accurately map the surfaces of the environment it is in. This simultaneous localization and mapping (SLAM), as shown in FIG. 1B at 115, has three crucial benefits, the primary being to define the features of the room/space that the XR device user is in, particularly the walls and other surfaces for the supplemental XR content to rendered on while also avoiding overlaying XR content on larger obstructions such as furniture items. There may be a threshold of size to determine whether to overlay XR content on one or more objects. For example, any object greater than two feet square may be the threshold for a large object. Second, for situations in which new XR device users join after the initial screen registration has taken place, using the combination of the screen location and SLAM data generated by the other XR device users as references would allow the XR device of these newly joined end users to align their headsets in the environment using key coordinates to marry the various XR devices'SLAM data so that they can derive the physical location of the primary media screen. Third, by storing and aggregating the SLAM data for the location tied to a specific media device allows for a more accurate definition of the physical space, which will give all users a more consistent experience by allowing users of different headsets with different scanning and mapping capabilities use of the same physical area, which for a large public space would be a beneficial capability for all XR device users. Moreover, with the SLAM data, the media server may accurately determine the exact position of each XR device (e.g., via sensor data such as accelerator data) within the environment.

FIG. 1B shows an illustrative scenario 110 in which an XR device generates SLAM data with multiple other XR devices, in accordance with some embodiments of this disclosure.

At step 2, the XR headset 112 captures an image of the television at 2:00PM-2:01PM on Jan. 31, 2024 that shows the visual markers 114 (e.g., oars in all four corners of the display of the television (e.g., television 104 of FIG. 1A)). In some embodiments, the media server may determine the dimensions and the location of the client device (e.g., television 104 of FIG. 1A) in relation to the XR device based at least in part on the visual marker. In some embodiments, the media server may generate SLAM data based on the visual marker located on the client device.

In FIG. 1B, the environment shown is a living room in a house that contains a television client device. The environment may be any type of environment such as a movie theater, a house, a classroom, a boardroom, a sports arena, an outdoor amphitheater, or similar venue designed for watching media content. In some embodiments, the media server may, in combination with the client device and/or XR device, generate the SLAM data. For example, in generating the SLAM data, the XR device may use an optical sensor (e.g., a camera) to capture an image of the environment and transmit this data to the media server. At step 3, the SLAM data 115 is generated based on the oars displayed in the captured image on the television. In some embodiments, there may be a plurality of images that are used to determine the SLAM data. For example, the XR device may capture multiple angles of the environment from different orientations to transmit to the media server. The SLAM data may include size, distance, and angle from the television to the XR headset. In some embodiments, at step 4, the media server may transmit the SLAM data to other XR devices 116 and 118. Moreover, the media server transmitting the SLAM data to an additional XR device causes the additional XR device to generate for display the XR content supplementing the media content based on the SLAM data. In some embodiments, the XR device itself may transmit the SLAM data to the additional XR device. In some embodiments, the media server may generate SLAM data for an environment, based at least in part on the determined dimensions and the location of the client device in relation to the XR device as described above. In some embodiments, the SLAM data is further based on locations of additional objects within the environment. For example, a movie theater may have multiple areas of visual media content that require SLAM data.

The XR device may read a different variant of a visual marker, namely an authentication marker, using its optical sensor (e.g., camera), and decode the data for authentication. For example, the authentication marker may be a QR code or other type of pointer that allows the optical sensor to decode the data and access authentication data (e.g., identifiers, or other similar credentials) for the XR device. The XR device may then compare the extracted identifier(s) or session key with its own stored credentials. The XR device's stored credentials are securely maintained in its memory and include its unique identifier, which was registered with the backend service during the initial setup. If the decoded identifier from the authentication marker matches the XR device's stored identifier, the XR device proceeds to connect with the client device or media server and generates for display the XR content. If there is no match, the XR device remains inactive, ensuring that only the intended devices participate in the experience.

In some embodiments, multiple XR devices in the same environment may share XR content (e.g., shared over a WAN/LAN). For instance, when multiple devices are registered with the same content but only one should participate, the media server may prioritize based on factors such as the device proximity to the media streaming device, user input preferences, or the active user profile on the media streaming device. Additionally, the media server may support a user interface on the client device where users can manually select which XR device(s) should participate in the current session, further enhancing control and personalization. The XR device may implement a client application running on the XR device to allow for media content playback and synchronization during the media content stream. This client application may either be installed ahead of time and could be manually launched, or the XR device/client device could trigger an action on the XR device by the display of a specific authentication marker to trigger either the launch of the client application, a request to install the client application or the launch of a web service. Additionally, this authentication marker may connect the XR device to either the client device/XR device or the media server. These devices will need to contain data for either or both of those end points or a key or token to retrieve that data from another source. One method is a media server, or the primary media device generates an authentication marker (e.g., QR code) containing a session key that the secondary XR device can retrieve from a known, trusted source. Once the XR device has retrieved the network and session information and has connected to the client device or media server, it will trigger the next phase of registration, which is the physical registration of the primary media display's location relative to the XR device. In some embodiments, the client device may implement the processes of the media server and the entire process may be local. The registration image may contain the endpoint of the client device.

In some embodiments, the XR device is configured to generate for display the XR content supplementing the media content based on the determined dimensions and the location of the client device displaying the media content. In some embodiments, the media server may be configured to instruct the XR device to generate for display the XR content. FIG. 1C shows an illustrative scenario 120 in which the media server generates XR content supplementing the media content, in accordance with some embodiments of this disclosure. The XR headset 122 generates XR content 126 which appears as a beach-surrounded-by-tidal-waves immersive experience to supplement Moana on the television 124. The media server may provide XR content to be overlayed in the physical world outside of the client device. The XR content is not overlayed on the client device, as the media server has spatial information of where the client device is relative to the XR device so as to preserve the immersion of the media content on the client device and provide non-intrusive supplemental XR content that does not overlay the client device. Moreover, this principle of non-intrusive supplemental XR content may be extended to not overlay XR content on larger furniture items to maintain higher levels of immersion. When XR content is generated for display, the client device communicates with the media server (e.g., backend service) to retrieve the identifiers of XR devices linked to that content. This communication may occur via a secure API, with the client device (e.g., the television 124 in FIG. 1C) sending a request containing metadata about the content being played, such as its unique content ID, channel ID, or profile ID. The media server responds with a list of authorized XR device identifiers, which could include device-specific identifiers such as MAC addresses, serial numbers, or unique device tokens that have been registered during the initial setup process.

In some embodiments, if the environment includes a plurality of assigned seating locations (e.g., a theater, an amphitheater, a stadium, or similar seated capacity space), the media server may generate a respective variant of SLAM data for one or more of the plurality of assigned seating locations. In some embodiments, the media server receives SLAM data from one or more XR devices that are located at one or more assigned seating locations. In some embodiments, the XR devices, without intervention of the media server, generate the respective variant of SLAM data for one or more of the assigned seating locations. But having multiple variants of SLAM data, the media server may compute the revised dimensions and location with enhanced efficiency instead of making this determination every time an XR device is detected at the same seat. In this embodiment, the same previous seat variant of SLAM data may be used by the media server.

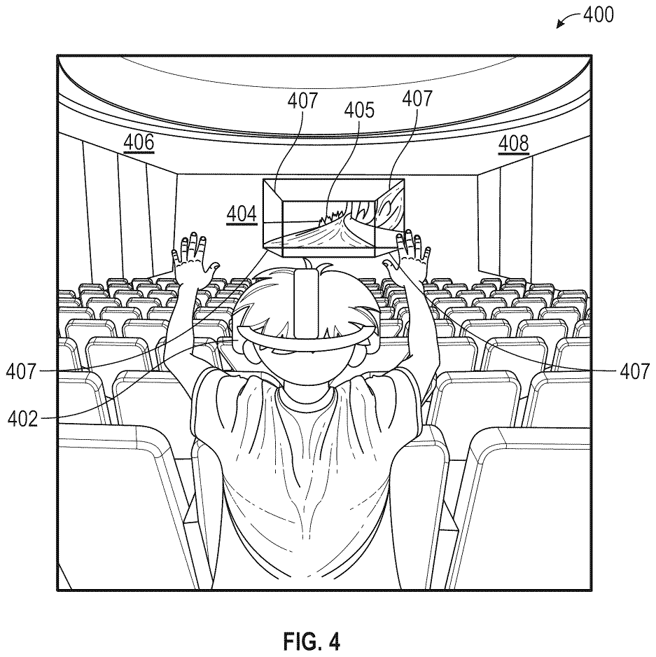

FIG. 4 shows an illustrative scenario 400 in which an XR device determines SLAM data of a theater environment, in accordance with some embodiments of this disclosure. In this example, the XR headset 402 determines SLAM data for the screen box 404 relative from the position of the XR headset within a theater environment (e.g., similar to FIG. 1B with a living room environment). Additionally, the XR headset determines the wall panels adjacent to the screen at 406 and 408.

The screen box denoted at 404 represent the outline of the movie screen drawn by the XR headset user as viewed from their location. The lines 407, between box 404 and box 405, show the projection from the user's drawn viewpoint to actual extents of the movie screen. This projection is created using the SLAM data of the theater generated by the user's XR headset, represented by wall panels 406 and 408 adjacent to the screen. The media server is then able to calculate the position of the XR device and the location of the user generated screen extents with the theater by aligning the user's SLAM data to the existing SLAM data generated by previous and other current XR headsets. Once the user's location is fixed in the theater, the media server is then able to project the user's generated extents to match the physical screen extents.

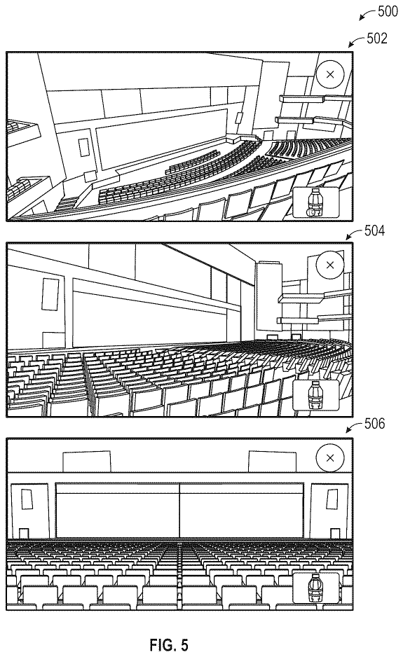

FIG. 5 shows an illustrative scenario 500 in which an XR device determines SLAM data of a theater environment from multiple locations, in accordance with some embodiments of this disclosure. At 502, an XR device determines the variant of SLAM data from an upper-deck assigned seating location. At 504, an XR device determines the variant of SLAM data from a lower-left-deck assigned seating location. The SLAM data is transmitted from the XR device to the media server. Each variant of SLAM data represents a different specific location within the movie theater. This is similar to FIG. 1B, where for example, a variant of SLAM data may be used for each cushion of a chair and/or couch. At 506, an XR device determines the variant of SLAM data from a lower-center-deck assigned seating location. In some embodiments, the media server, receiving the variant SLAM data for these assigned seating locations may generate a respective variant of SLAM data for each of the plurality of assigned seating locations of 502, 504, and 506. At a later point in time, if another XR device uses one of the seating locations of 502, 504, or 506, the media server may transmit a previously determined respective variant of SLAM data for the corresponding assigned seating location. These locations, in addition to other key feature locations detected by the spatial mapping of the environment by the XR device, can be shared with the media server to aid any late-joining additional XR devices with a spatial context with using the key feature locations and known SLAM techniques to align themselves properly in the environment without the need to re-run the screen registration process, which is useful public settings; for private settings, such as home viewing, the screen registration process could be built into the pause functionality of the primary media source to allow late-joining devices the same registration process to further refine the primary screen tracking values.

In some embodiments, if the client device is not capable of rendering these visual markers on screen, there are multiple alternative solutions for the XR device to define the dimensions of the client device. For example, the XR device may detect user-drawn edges of the display of the client device, where the drawn edges may be done via a user's finder or other device tracked by the XR device. In another embodiment, the XR device may move virtual objects to the extent of the dimensions of the display of the client device based on their view.

Neither of these approaches would require the XR device to physically interact with the screen itself, rather, this may be accomplished from the comfort of the chair or couch the user intend to watch the media content from. Additionally, once this initial placement is made, it could be refined using known techniques for the specific XR device, such as pinching a corner of the screen extents to reposition it, or even using voice commands to make adjustments. Once the XR device confirms dimensions of the display of the client device, it would then send to the media server the SLAM data of the environment created by the XR device. In this example, the media server may remap the display dimensions to match the location of the screen in the physical environment.

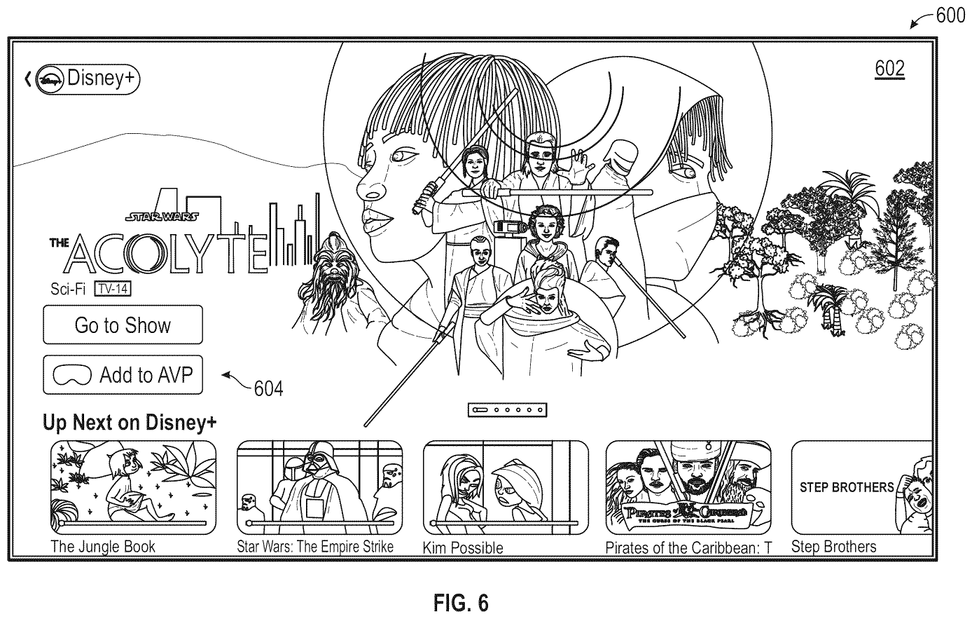

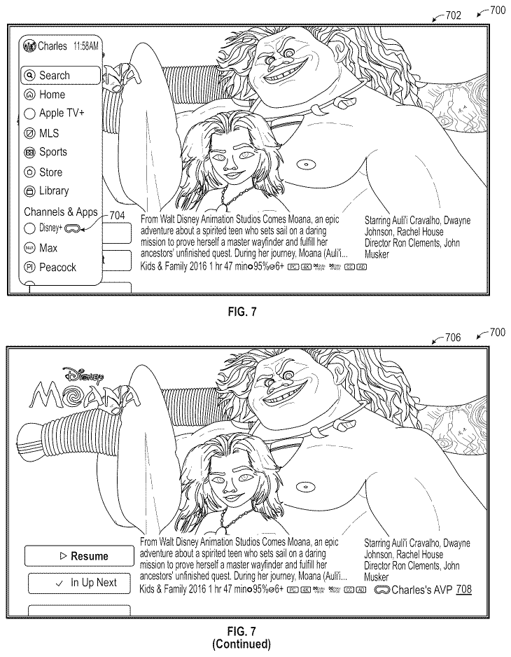

FIG. 6 shows an illustrative scenario 600 in which a user interface on the client device displays an option for supplemental XR content, in accordance with some embodiments of this disclosure. The user interface displays a home screen for a streaming service for showcasing the television show “The Acolyte” at 602. The user interface may include selections for requesting XR content. Continuing with the example, there are selection buttons that include “Go to Show” and the “Add to Apple Vision Pro (AVP)” at 604. FIG. 7 shows an illustrative scenario 700 in which another user interface on the client device displays options for supplemental XR content, in accordance with some embodiments of this disclosure. At 702, a user interface allows selection of the particular streaming service (e.g., Max, Peacock, or Disney+). The user interface may indicate whether XR content is available with the streaming service. For example, at 704, there is a visual indicator of a VR headset icon beside the Disney+. Upon a selection of the Disney+streaming service, the movie Moana appears with the option to resume watching. At 708, the user interface indicates that XR content is available and selected for this media content as Charle's AVP is selected as the XR device for the XR content supplementing the media content.

In some embodiments, the authentication marker displayed on the primary media device includes or indicates specific data that identifies which XR devices are authorized to participate in the XR experience. This authentication marker serves as a secure method for controlling and managing device access within the XR system, ensuring that only designated XR devices can engage in the augmented experience. The authentication marker may encode various types of device-specific identifiers, such as serial numbers, MAC addresses, or unique session keys that are dynamically generated for each viewing session. The encoded data is structured to be machine-readable by the XR device's camera and is typically represented as a QR code, data matrix code, or another visually encoded format.

In some embodiments, the media streaming device may generate the authentication marker based on the current session information and the list of authorized XR devices. This list is either retrieved from a backend service or generated locally based on preconfigured settings.

The authentication marker's content is encrypted or otherwise secured to prevent unauthorized interception or duplication. The encryption may use a symmetric key shared between the media streaming device and the XR device, or it may rely on public-key cryptography where the XR device holds the corresponding private key for decryption. When the authentication marker is displayed on the primary media device's screen, the XR device captures the image using its camera and decodes the embedded data. The XR device then extracts the relevant identifiers or session keys and compares them against its own stored credentials. If the extracted identifier matches the XR device's stored identifier, or if the session key is validated, the XR device proceeds to establish a connection with the media streaming device or backend service, allowing the XR experience to begin. If no match is found or the validation fails, the XR device remains inactive, thus preventing unauthorized or unintended devices from participating in the XR experience.

In some embodiments, the media server may perform session authorization in real time. In this implementation, the media streaming device generates a unique session key each time a new XR experience is initiated. This session key is included in the authentication marker along with the device-specific identifiers. The backend service or media streaming device then monitors active sessions and cross-checks each XR device's authorization status in real time. As part of the real-time authorization, the system may also consider additional contextual factors, such as the device's proximity to the media streaming device, the current user profile, or specific content rights associated with the media. Additionally, the backend service might need to connect to third-party systems for the validation and authentication of the XR device's status to view specific content. Scenarios such as public movie theaters that may require a special ticket or renting media content at home that may require an additional fee to view the XR content would need to be attached to the XR device user's account.

In some embodiments, the media server may receive a request to generate for display the XR content supplementing the media content from an additional XR device. FIG. 8 shows an illustrative scenario 800 in which yet another user interface on the client device displays multiple options for supplemental XR content, in accordance with some embodiments of this disclosure. At 802, a user interface is overlayed over the client device display interface that includes XR device controls at 804. At 806, when the XR controls at 808 are selected, a new set of options are displayed at 810. This new set of options includes toggling XR content to be enabled for Charles's AVP, daughter's AVP, and wife's AVP. The daughter's AVP may be the additional XR device requesting the supplemental XR content. The media server may determine that the XR device is a primary device associated with a service account for viewing the media content. Continuing with the example above, the media server may determine Charles's AVP is the primary device that is associated with the Disney+account, while daughter and wife AVP accounts are secondary accounts. The media, based on this determining, may cause the XR device to generate for display a prompt to authorize the additional XR device. Based on an interaction with the prompt, the media server may authorize the additional XR device to generate for display the XR content supplementing the media content. For example, the user interface for Charles's AVP may include a prompt that requests authorization (e.g., an allow or deny request) to allow for daughter's AVP to access the XR content. Subsequent to granting allowance, the media server may transmit, to the additional XR device, instructions to generate for display the XR content supplementing the media content for the additional XR device. Continuing with the example above, the media server provides the Disney+XR content that supplements Moana to the daughter's AVP. In some embodiments, the media server may transmit, to the additional XR device, previously determined SLAM data (e.g., the media server may transmit Charles's SLAM data from his AVP to the daughter's AVP). In some embodiments, the media server may transmit, to the additional XR device, XR content previously generated for a previous XR device (e.g., the media server may transmit Charles's stored XR content from his AVP to the daughter's AVP). In some embodiments, the media server may transmit, to the additional XR device, authentication information previously generated for a previous XR device (e.g., the media server may transmit Charles's stored authentication from his AVP to the daughter's AVP).

In some embodiments, the media server may generate for display a user interface element for selecting a level of access to the XR content for the additional XR device, wherein the user interface element includes an option to allow access to the XR content, and an option to disallow access to the XR content. As mentioned above, the user interface for Charles's AVP may include a prompt that requests authorization (e.g., an allow or deny request) to allow for daughter's AVP to access the XR content. Based on a selection of the option to disallow access to the XR content, the media server may cause the additional XR device to cease generating for display the XR content supplementing the media content. In this manner, the access may be used as parental controls for the media content. In some embodiments, the user interface element includes an option for allowing partial access to the XR content. Based on a selection of the option allowing the partial access to the XR content, the media server causes the additional XR device to generate a version of the XR content with fewer XR elements. For example, as shown in FIG. 1C, the XR content 126 appears as a beach-surrounded-by-tidal-waves immersive experience to supplement Moana on the television 124. Fewer XR elements may include the same as shown in 1C with fewer waves, or no waves and just a beach.

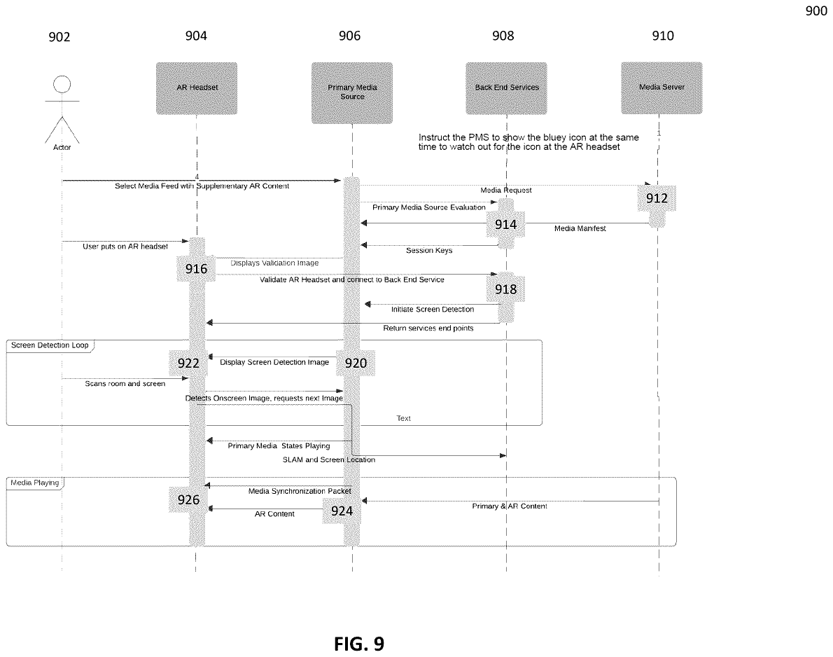

FIG. 9 is a sequence diagram 900 of a detailed illustrative process for displaying the visual marker at a time that is based on timing information, in accordance with some embodiments of this disclosure. The sequence diagram includes an actor/user 902, an AR headset 904, primary media source 906, backend service (e.g., module of media server) 908, and media server 910. The primary media source receives a selection of media feed with supplementary AR content (e.g., similar to FIG. 1, Moana media content is selected with XR supplemental content for Moana). At 912, the media server receives the media request that includes display instructions to display a Bluey icon and at the same time to watch out for the icon on the AR headset, and returns the appropriate manifest to the backend service. At 914, the backend service receives a primary media source evaluation and creates session keys for display on primary media source. At 916, the user puts on the AR headset and the AR headset detects and deciphers a validation image and connects with backend service for validation. At 918, the backend service validates the AR headset and shares information with the primary media source, and returns services and end points to the AR headset. At 920, the primary media source begins displaying screen detection images (e.g., visual markers as shown in FIG. 1B at 114). At 922, the AR headset scans the room and screen to detect screen detection images and performs SLAM on physical environment (e.g., similar to FIG. 1B at 115). The AR headset detects the onscreen image and requests the next image. At 924, the primary media source begins playing the media feed and delivering AR content contained in the feed to the AR headset at the SLAM and screen location and sends synchronization packets to the AR headset (e.g., similar to FIG. 1C at 126). At 926, the AR receives the media synchronization packet and the headset generates for display appropriate AR content.

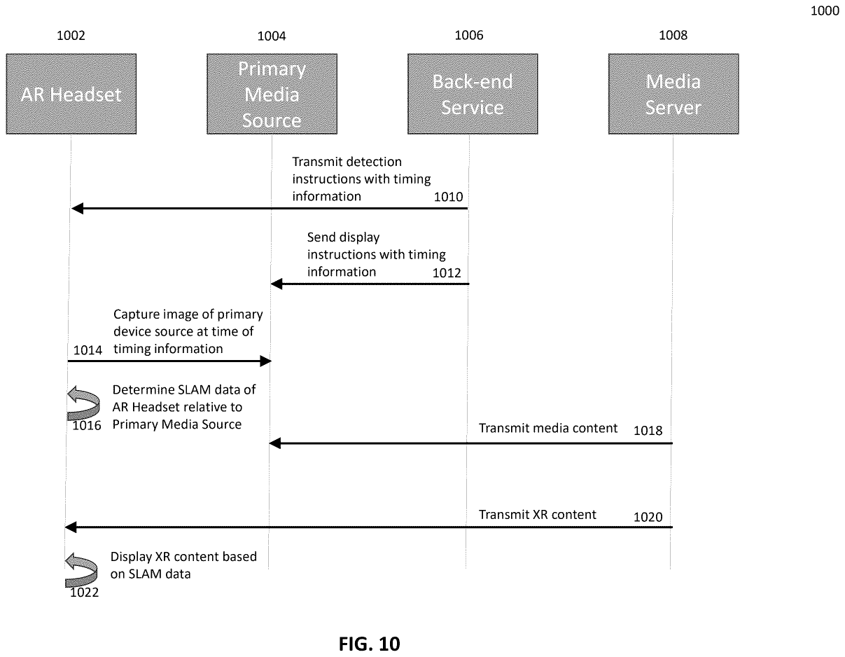

FIG. 10 is a sequence diagram 1000 of a detailed illustrative process for displaying XR content based on SLAM data, in accordance with some embodiments of this disclosure. The sequence diagram includes an AR headset 1002, primary media source 1004, backend service (e.g., module of media server) 1006, and media server 1008. At 1010 (e.g., similar to 912 in FIG. 9), the backend service 1006 transmits detection instructions with timing information to the AR headset 1002 (similar to FIG. 1A at step 1b). At 1012, the backend service 1006 sends display instructions with timing information to the primary media source 1004 (similar to FIG. 1A at step la). At 1014 (e.g., similar to 922 in FIG. 9 where the AR headset scans the room and screen detecting the onscreen image), the AR headset captures an image of primary device source at time of timing information from the primary media source (similar to FIG. 1B at step 2). At 1016, the AR headset determines SLAM data of AR headset relative to primary media source (similar to FIG. 1B at step 3). At 1018 (e.g., similar to 922 in FIG. 9, where the primary media starts playing), the media server transmits media content to the primary media source (similar to FIG. 1C at 124). At 1020, the media server transmits XR content to the AR headset 1002 (e.g., XR headset 122 of FIG. 1C). At 1022, the AR headset 1002 generates for display XR content based on SLAM data.

In some embodiments, the client device that is handling the downloading of the primary media stream can additionally handle the downloading of the XR content and delivery it to the XR device(s) and maintain synchronization with the XR device(s) so that content will be displayed at the appropriate times. The client device may be a television that is serving as the source for the primary video stream or a device like an Apple TV or Roku that is streaming the primary video and then delivering that XR content to the XR device(s) and maintaining synchronization transactions with the XR device(s) to maintain consistent media behavior across both devices.

In some embodiments, if the local device is not capable of handling the additional media stream and delivering it to the XR device or maintaining synchronization transactions with the XR device, then an offsite backend service will need to be engaged to provide the XR content to the XR device and maintain synchronization transactions. This service will need to be connected to the primary device (e.g., television) as it will need to be updated with the current state of the primary media playback to be able to provide that to the XR device. If the XR headset is capable of managing it, the manifest file for the XR content can also be delivered directly to the XR headset, and it is then responsible for the downloading and managing of the XR headset's own content delivery as the synchronization transactions will provide the timing cues to know when content needs to be ready for display, with the initialization of the content downloads driven by either the manifest file itself or the XR device's internal logic.

In some embodiments, a primary local media device (e.g., television) is able to handle both the data transmission and synchronization transactions to the XR device. This is the optimal solution as all of the network transactions for data delivery to the XR headset and synchronization are local to the devices. In some embodiments, the primary local media device is not able to handle either the data transmission or the synchronization transactions to the secondary XR device. In these embodiments, the backend service provides both the secondary XR content and the synchronization transactions to the secondary XR device. The primary media source sends the synchronization transactions back to the media service, which provides them to the backend service so it can deliver them to the secondary XR device. In some embodiments, primary local media device may transmit data, but not the synchronization transactions, to the secondary XR device. The backend service provides the synchronization transactions to the secondary XR device. The primary media source sends the synchronization transactions back to the media service, which provides them to the backend service so it can deliver them to the secondary XR device. In some embodiments, the primary local media device is not able to handle the data transmission but is able to provide the synchronization transactions to the secondary XR device. The backend service provides the XR content to the secondary XR device. In some embodiments, the primary local media device is not able to handle either the data transmission or the synchronization transactions to the secondary XR device nor is it able to provide any updates back to the backend service, so any communication with the XR device needs to be optical, which impacts the playback of the primary media source, which is suboptimal but does provide a capability for legacy devices to be used. In these embodiments, media delivery is handled by the backend service and synchronization transactions are delivered optically onscreen for the secondary XR device to visually capture and then decode to allow for synchronization of secondary XR content to the primary media source content.

In some embodiments, in scenarios where XR cameras are able to provide better than real-time optical capture and image tracking, the synchronization may be done using visual markers. This is analogous to how traditional film reels were synchronized, to deliver the synchronization markers visually instead, rather than synchronizing the reel via a network transaction. Additionally, if network bandwidth is not an issue, each headset can handle the media content downloads directly from the content delivery service. This would allow the XR headsets to be completely de-coupled from the primary media service device.

To prevent an impact to the user experience, the media server incorporates synchronization mechanisms that align the timing of the visual marker display with the content playback. For example, the media streaming device may insert the visual marker at specific frames or scenes during the initial playback phase to ensure that the XR device has sufficient time to detect and process the marker. The backend service may also log and track these synchronization points, enabling the XR device to re-synchronize if the content is paused, rewound, or fast-forwarded.

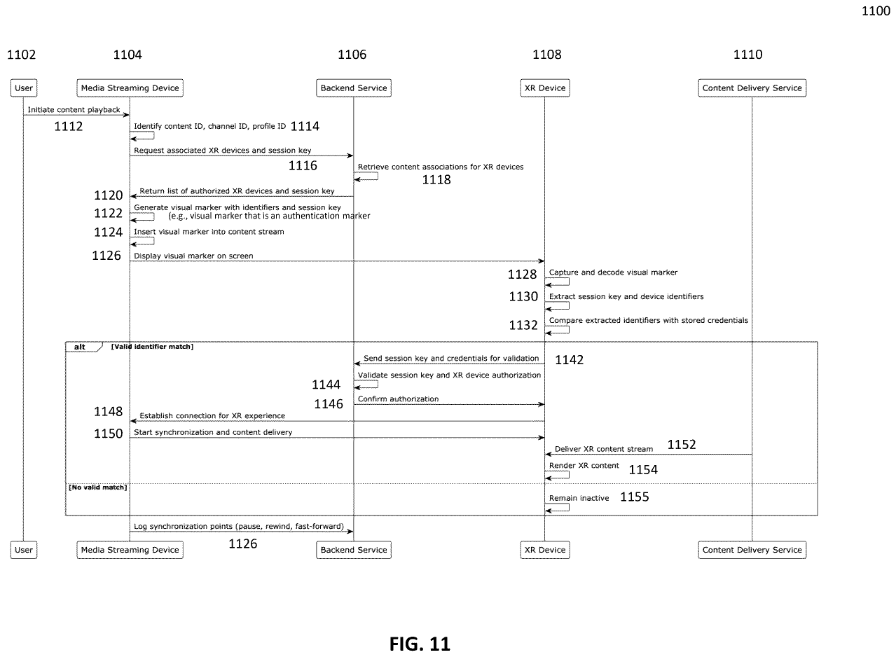

FIG. 11 is a sequence diagram of a detailed illustrative process 1100 for implementing synchronization mechanisms to align the timing of the visual marker display with the media content playback, in accordance with some embodiments of this disclosure. The sequence diagram includes a user 1102, media streaming device 1104, backend service (e.g., module of media server) 1106, XR device 1108, and content delivery system 1110. The media streaming service receives selection from the user at 1112 to initiate content playback and identifies the content ID, channel ID, and profile ID at 1114. At 1116, the backend service receives the request associated with XR devices and the session key from the media streaming device. At 1118, the backend service retrieves content associations for the XR devices and, at 1120, returns a list of authorized XR devices and the session key to the media streaming device. The media streaming device generates a visual marker, which is an authentication marker having identifiers, and a session key at 1122; inserts the authentication marker into the content stream at 1124; and displays the authentication marker at 1126. The XR device captures and decodes the authentication marker at 1128; extracts the session key and device identifiers at 1130; and compares the device identifiers with stored credentials to determine a match at 1132. If there is a determined match, the synchronization mechanism can be seen at 1142, where the XR device sends session key and credentials for validation. The key may be a PKI, symmetric key, or other encryption mechanism for authentication. At 1144, the backend service validates session key and XR device authorization and, at 1146, confirms authorization. The connection is established between the XR device and the media streaming service at 1148. The XR device receives 1150 the synchronization start and content delivery. The content delivery service delivers 1152 the XR content stream to the XR device where the XR content is rendered 1154. The media streaming device may log synchronization points (e.g., pause, rewind, and fast-forward). If there is no valid identifier for authentication, the XR device remains inactive at 1155. The media streaming service may log synchronization points (e.g., pause, rewind, and fast-forward) at 1157.

Regarding synchronization, in some embodiments, during playback of the primary media feed, the primary media device will need to send timing synchronization events to the secondary XR device. These timing events ensure that the media playback on the XR device is synchronized to the primary media feed. These timing events also allow for the secondary XR media to have the ability to be time-synchronized to specific scenes or events in the media feed, such as expanding a space battle in a “Star Wars” movie to encompass the entire room, spreading lava beyond the screen if a volcano erupts on screen to really immerse the XR user, or even having a character pop off screen at the end of their scene to join the users and provide commentary on the next scene. Additionally, having this synchronization allows the XR device, if it is responsible for the media downloads, to be triggered when the next download needs to occur ahead of its display in the XR device, thus keeping the XR device in step as the primary media feed is paused, stopped, fast-forwarded or rewound to a prior scene so that the XR device's output is always matching what is happening on the primary media feed. In some embodiments, the media server may implement a multicast network packet that would provide the current time of the primary media feed and the state that the primary media feed is in: stopped, playing, paused, fast-forwarded or re-wound.

In some embodiments, an ambient XR backend service is implemented to ensure interoperability between multiple devices. The XR backend service may provide a trusted service for the XR headset to validate the session ID provided by the primary media service and provide details for the primary media service to be handling content delivery and/or synchronization. The XR backend service may store and aggregate the SLAM data and screen location data to be shared with any additional XR headsets that join after registration. The XR backend service may provide content delivery if the primary media device is not capable. The XR backend service may provide synchronization transactions if the primary media device is not capable of doing so. The SLAM data and screen location data may be deleted at the end of the media session for the case of private showings, or aggregated to provide increasingly accurate data for public locations using known multi-user SLAM solutions to refine the overall location data.

In some embodiments where the media server is providing supplemental XR content in a multi-seat environment (e.g., a movie theater), content management is an important consideration, particularly for public showings, as most likely the end users'devices will be their own, so the content needs to be removed as soon as it is no longer needed. This is done both to minimize the impact on the end user's device but also to minimize the risk to the content creators by ensuring that all the media is end-to-end encrypted and follows the same license rights as the original source media. In some embodiments, joining after the initialization phase will be slightly different as there would be no opportunity for the XR headset to see the primary media display the visual marker to initiate the XR device application to start the initialization process. This could be handled on a pause screen for private showings or through a mobile app or even a physical image at a public showing to simplify all access for devices. But this does not solve for the second phase of initialization with screen detection in cases where the primary media cannot be paused to allow for a secondary initialization process for late-joining devices. This is why every device that initializes needs to upload their SLAM and screen detection locations so that data can be aggregated and shared with the late-joining devices to help them solve their location in the physical environment relative to the primary media screen so that it is not occluded by the XR content displayed in the XR headset.

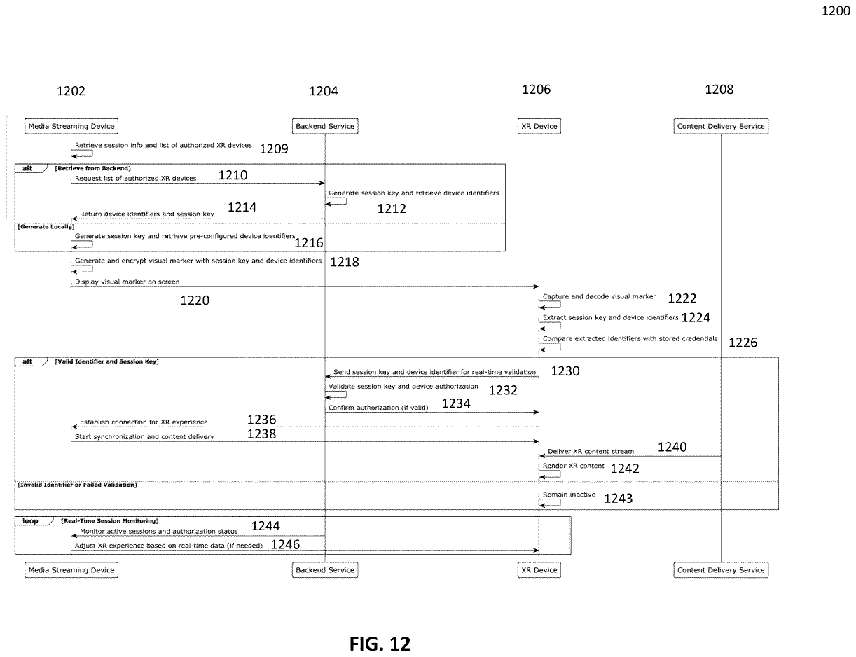

FIG. 12 is a sequence diagram of a detailed illustrative process 1200 for a backend service connecting to a third-party content delivery system, in accordance with some embodiments of this disclosure. The sequence diagram includes a media streaming device 1202, backend service (e.g., module of media server) 1204, XR device 1206, and content delivery system 1208. The media streaming device retrieves the session data and list of authorized XR devices at 1209. The backend service might need to connect to third-party systems for the validation and authentication of the XR device's status to view specific content. For example, a public movie theater that may require a special ticket or renting media content at home that may require an additional fee to view the XR content would need to be attached to the XR device user's account. The media streaming device requests 1210 a list of authorized XR devices from the backend service. The backend service generates 1212 a session key and retrieves the device identifiers. The backend service returns 1214 the device identifiers and session key. The media streaming device generates a session key and retrieves pre-configured device identifiers at 1216, generates and encrypts visual marker with session key and device identifiers at 1218, and generates for display the authentication marker on the interface (e.g., screen) of the XR device at 1220. The XR device captures and decodes the authentication marker at 1222, extracts the session key and device identifiers at 1224, and compares the extracted identifiers with the credentials at 1226. If the identifier is valid for the session, the XR device sends 1230 the session key and device identifier for real-time validation to the backend service. The backend service validates 1232 and confirms 1234 the validation. The XR device then establishes 1236 connection for the XR experiences with the media streaming device and the synchronization is established 1238 for content delivery. The content delivery system delivers 1240 the XR content stream, where the XR device renders 1242 the XR content. If the identifier is invalid for the session, the XR device remains inactive at 1243. The backend service may continue to monitor active sessions and authorize as needed 1244 and may adjust 1246 the XR content based on real-time data.

In some embodiments, the media server may provide an option on the media streaming device to enable or disable the XR experience, functioning similarly to how users toggle closed captions or subtitles. This option is integrated into the media streaming device's user interface, allowing users to easily control the XR feature. The option may be presented as a toggle switch or checkbox within the settings menu, or as an on-screen overlay that can be accessed during content playback. When a user selects the option to enable or disable the XR experience, the media streaming device generates a control signal reflecting this change. Depending on the system architecture, this control signal is either transmitted directly to the XR device or routed through a backend service. For instance, if the media streaming device is responsible for managing synchronization and content delivery locally, the control signal is sent directly to the XR device via a local network. Alternatively, if the system relies on a backend service to manage XR content, the control signal is transmitted to the backend service, which then relays the appropriate instructions to the XR device. When the XR experience is disabled, the media streaming device ceases all XR-related operations, including generating visual markers, sending synchronization packets, and/or delivering XR content. This effectively pauses the XR experience, ensuring that no additional XR content is rendered on the XR device. The media streaming device may also send a stop or pause command to the XR device, signaling it to terminate or suspend any ongoing XR sessions. This suspension may involve the XR device entering a low-power state or returning to a standby mode, ready to reactivate if the XR experience is re-enabled.

If the user chooses to re-enable the XR experience, the media server may resume the necessary operations to restart the XR content delivery and synchronization. The media streaming device generates and displays the visual marker, re-establishes synchronization signals, and, if needed, initiates a new connection with the backend service to retrieve updated XR content. The XR device, upon detecting the visual marker or receiving the control signal, resumes its XR operations, such as content rendering and synchronization. The reactivation process is designed to be seamless, allowing users to toggle the XR experience on or off without interrupting the primary media playback or requiring a restart of the session.

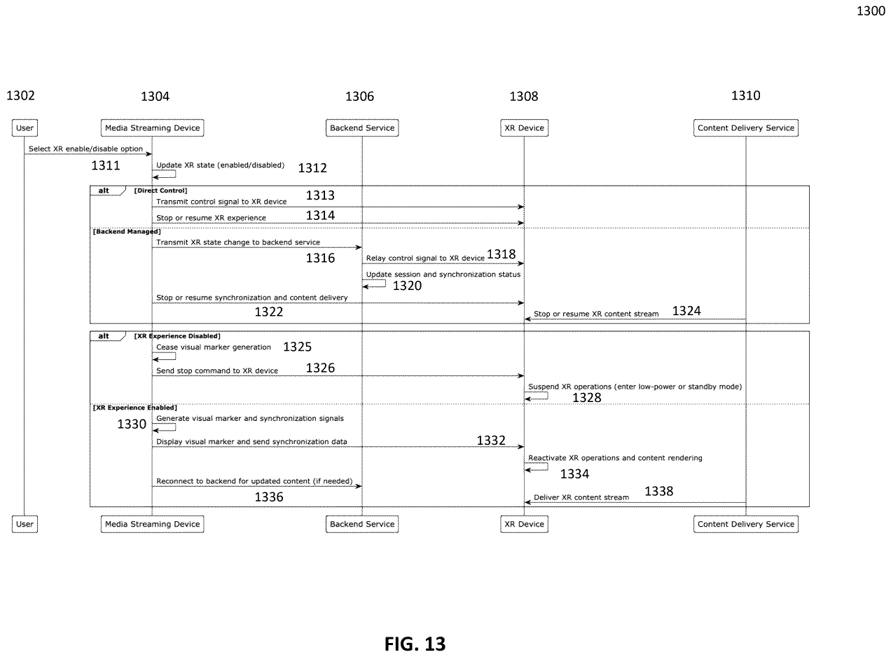

FIG. 13 is a sequence diagram of a detailed illustrative process 1300 for the backend service re-enabling the XR content for an XR device, in accordance with some embodiments of this disclosure. The sequence diagram includes a user 1302, a media streaming device 1304, backend service (e.g., module of media server) 1306, XR device 1308, and content delivery system 1310. The media streaming device receives selection of XR enablement from the user at 1311 and updates the XR state to enabled at 1312. The media streaming device may then transmit control signal to the XR device 1313 to stop/resume the XR content 1314. The backend service receives the change-state 1316, relays control signal to the XR device 1318, and finally updates the session and synchronization status 1320. The media streaming device stops/resumes the synchronization and content delivery to the XR device 1322, and the content delivery services stops/resumes the XR content 1324. In embodiments where the XR experience is disabled, the media streaming device ceases visual marking generation 1325 and sends a stop command to the XR device 1326. The XR device then suspends XR operations 1328. In embodiments where the XR experience is enabled, the media streaming device generates the visual marker and synchronization signals 1330 and displays the visual markers and synchronization data to the XR device 1332. The XR device reactivates the XR operations and content rendering 1334 and receives the XR content stream from the content delivery service 1338. The media streaming device may connect to the backend service for updated content if needed 1336.

In some embodiments, the media server allows users to adjust the level of XR immersion according to their preferences, offering configurable options on the media streaming device. The media streaming device presents a range of XR experience levels, from minimal augmentation to full immersion, which the user can select before or during content playback.

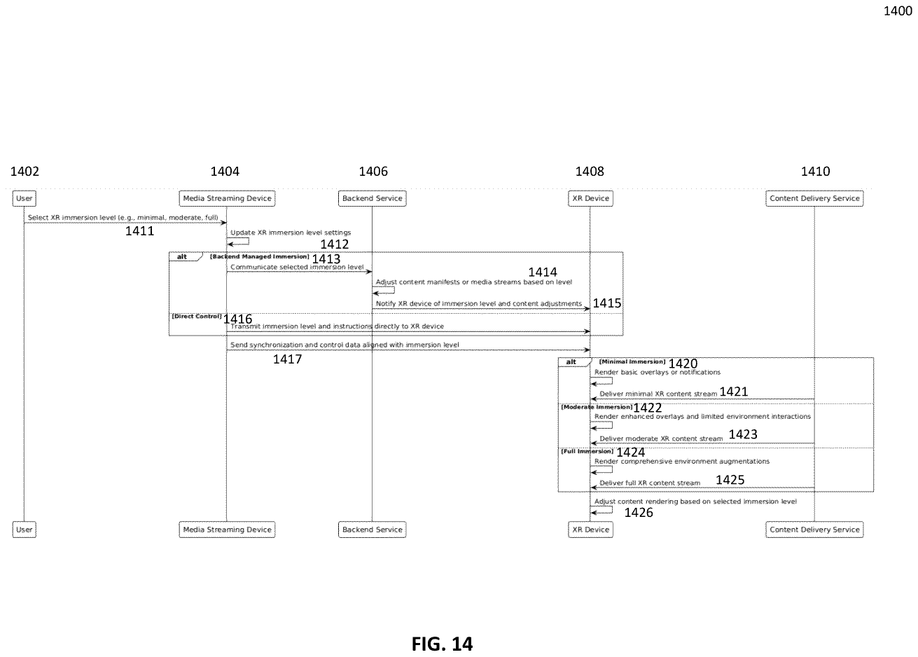

Technically, this is implemented by varying the type and amount of XR content delivered to the XR device. For example, minimal immersion might involve sending only basic overlays or notifications, while full immersion could include comprehensive environmental augmentations. The media streaming device communicates the selected level of immersion to the backend service or directly to the XR device, which then adjusts its content rendering accordingly. The implementation includes managing content manifests or media streams based on the selected experience level, ensuring that the XR content aligns with the user's chosen degree of augmentation. FIG. 14 is a sequence diagram of a detailed illustrative process 1400 for adjusting the level of XR immersion according to a preference, in accordance with some embodiments of this disclosure. The sequence diagram includes a user 1402, a media streaming device 1404, backend service (e.g., module of media server) 1406, XR device 1408, and content delivery system 1410. The media streaming device receives selection of XR content immersion level from the user (e.g., minimal, moderate or full) at 1411 and updates the XR immersion level setting accordingly at 1412. In a backend-managed immersion embodiment, the media streaming device communicates the selected immersion level at 1413 and has the backend service adjust the content manifests based on the immersion level at 1414. The backend service notifies the XR device of the immersion level and the content adjustments at 1415. In a direct control embodiment 1416, the media streaming device directly transmits the immersion level instructions to the XR device at 1416 and sends synchronization and control data corresponding to the immersion level to the XR device at 1417. In some embodiments, if minimal immersion is selected, the XR device renders a basic overlay or notification at 1420 and the content delivery system delivers the minimal XR content stream at 1421. In some embodiments, if moderate immersion is selected, the XR device renders a moderate overlay or notification at 1422, and the content delivery system delivers the moderate XR content stream at 1423. In some embodiments, if full immersion is selected, the XR device renders a full overlay or notification at 1424, and the content delivery system delivers the full XR content stream at 1425. The XR device may continue to adjust the XR content rendering based on the selected immersion level at 1426.

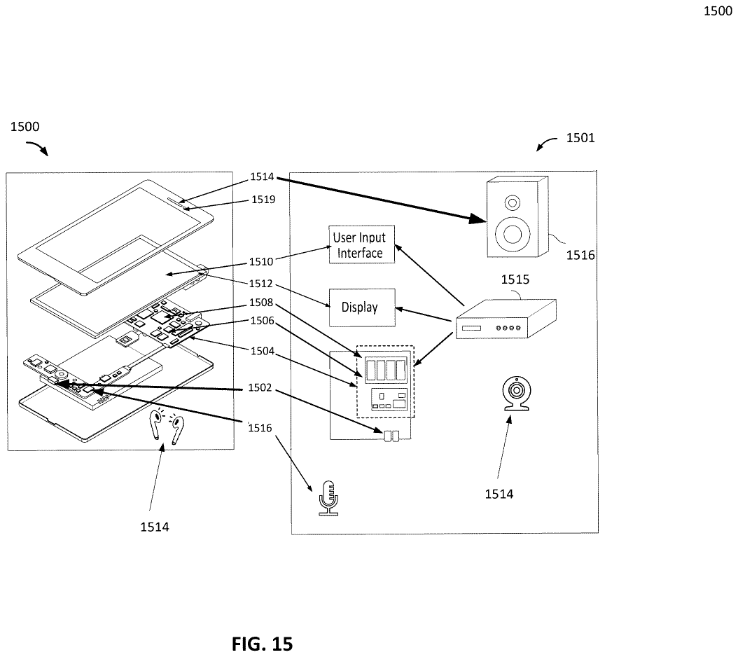

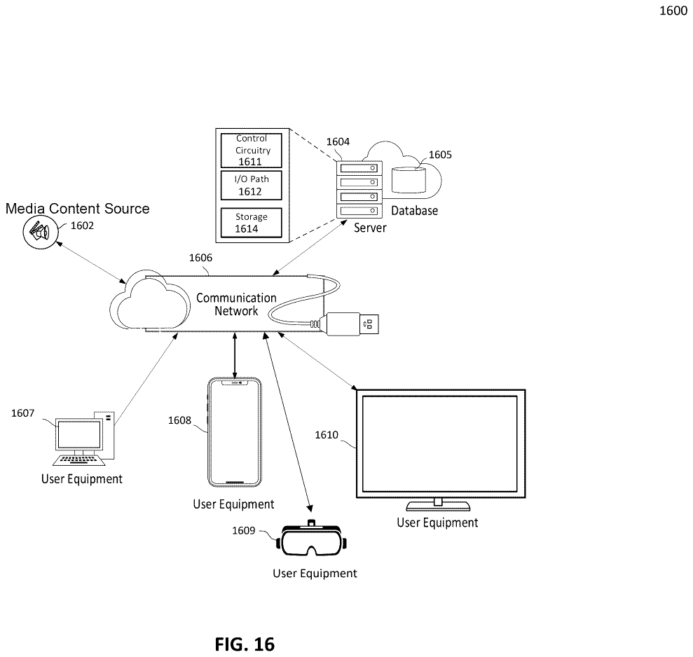

FIGS. 15-16 describe illustrative devices, systems, servers, and related hardware for a media application for efficient navigation of a plurality of media assets and for playing post-credit content in media assets by overriding play-next logic, in accordance with some embodiments of this disclosure. FIG. 16 shows generalized embodiments of illustrative user devices 1500 and 1501. For example, user equipment device 1500 may be a smartphone device, a tablet, smart glasses, a virtual reality or augmented reality device (e.g., AR goggles, AR headset, AR implemented via smartphone, tablet, or computer), or any other suitable device capable of consuming media assets and capable of transmitting and receiving data over a communication network. In another example, user equipment device 1501 may be a user television equipment system or device. User television equipment device 1501 may include set-top box 1515. Set-top box 1515 may be communicatively connected to microphone 1516, audio output equipment (e.g., speaker or headphones 1514), and display 1512. In some embodiments, microphone 1516 may receive audio corresponding to a voice of a user, e.g., a voice command. In some embodiments, display 1512 may be a television display or a computer display. In some embodiments, set-top box 1515 may be communicatively connected to user input interface 1510. In some embodiments, user input interface 1510 may be a remote control device. Set-top box 1515 may include one or more circuit boards. In some embodiments, the circuit boards may include control circuitry, processing circuitry, and storage (e.g., RAM, ROM, hard disk, removable disk, etc.). In some embodiments, the circuit boards may include an input/output path. More specific implementations of user equipment devices are discussed below in connection with FIG. 16. In some embodiments, device 1500 may comprise any suitable number of sensors, as well as a GPS module (e.g., in communication with one or more servers and/or cell towers and/or satellites) to ascertain a location of device 1500.

Each one of user equipment device 1500 and user equipment device 1501 may receive content and data via input/output (I/O) path 1502. I/O path 1502 may provide content (e.g., broadcast programming, on-demand programming, Internet content, content available over a local area network (LAN) or wide area network (WAN), and/or other content) and data to control circuitry 1504, which may comprise processing circuitry 1506 and storage 1508. Control circuitry 1504 may be used to send and receive commands, requests, and other suitable data using I/O path 1502, which may comprise I/O circuitry. I/O path 1502 may connect control circuitry 1504 (and specifically processing circuitry 1506) to one or more communications paths (described below). I/O functions may be provided by one or more of these communications paths, but are shown as a single path in FIG. 16 to avoid overcomplicating the drawing. While set-top box 1515 is shown in FIG. 16 for illustration, any suitable computing device having processing circuitry, control circuitry, and storage may be used in accordance with the present disclosure. For example, set-top box 1515 may be replaced by, or complemented by, a personal computer (e.g., a notebook, a laptop, a desktop), a smartphone (e.g., device 1500), a tablet, a network-based server hosting a user-accessible client device, a non-user-owned device, any other suitable device, or any combination thereof.

Control circuitry 1504 may be based on any suitable control circuitry such as processing circuitry 1506. As referred to herein, control circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 1504 executes instructions for the Media application stored in memory (e.g., storage 1508). Specifically, control circuitry 1504 may be instructed by the Media application to perform the functions discussed above and below. In some implementations, processing or actions performed by control circuitry 1504 may be based on instructions received from the Media application.

In client/server-based embodiments, control circuitry 1504 may include communications circuitry suitable for communicating with a server or other networks or servers. The media application may be a stand-alone application implemented on a device or a server.

The media application may be implemented as software or a set of executable instructions. The instructions for performing any of the embodiments discussed herein of the media application may be encoded on non-transitory computer-readable media (e.g., a hard drive, random-access memory on a DRAM integrated circuit, read-only memory on a BLU-RAY disk, etc.). For example, in FIG. 16, the instructions may be stored in storage 1508 and executed by control circuitry 1504 of a device 1500.

In some embodiments, the media application may be a client/server application where only the client application resides on device 1500, and a server application resides on an external server (e.g., server 1604 and/or server 1616). For example, the media application may be implemented partially as a client application on control circuitry 1504 of device 1500 and partially on server 1604 as a server application running on control circuitry 1611.

Server 1604 may be a part of a local area network with one or more of devices 1500 or may be part of a cloud computing environment accessed via the internet. In a cloud computing environment, various types of computing services for performing searches on the internet or informational databases, providing storage (e.g., for a database) or parsing data are provided by a collection of network-accessible computing and storage resources (e.g., server 1604), referred to as “the cloud.” Device 1500 may be a cloud client that relies on the cloud computing capabilities from server 1604 to determine whether processing should be offloaded and facilitate such offloading. When executed by control circuitry 1504 or 1611, the media application may instruct control circuitry 1504 or 1611 circuitry to perform processing tasks for the client device and facilitate a media consumption session integrated with social network services. The client application may instruct control circuitry 1504 to determine whether processing should be offloaded.

Control circuitry 1504 may include communications circuitry suitable for communicating with a server, social network service, a table or database server, or other networks or servers. The instructions for carrying out the above-mentioned functionality may be stored on a server (which is described in more detail in connection with FIG. 16).

Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communication networks or paths (which is described in more detail in connection with FIG. 16). In addition, communications circuitry may include circuitry that enables peer-to-peer communication of user equipment devices, or communication of user equipment devices in locations remote from each other (described in more detail below).

Memory may be an electronic storage device provided as storage 1508 that is part of control circuitry 1504. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 1508 may be used to store various types of content described herein as well as media application data described above. Nonvolatile memory may also be used (e.g., to launch a boot-up routine and other instructions). Cloud-based storage may be used to supplement storage 1508 or instead of storage 1508.

Control circuitry 1504 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 1504 may also include scaler circuitry for upconverting and down converting content into the preferred output format of user equipment 1500. Control circuitry 1504 may also include digital-to-analog converter circuitry and analog-to-digital converter circuitry for converting between digital and analog signals. The tuning and encoding circuitry may be used by user equipment device 1500, 1501 to receive and to display, to play, or to record content. The tuning and encoding circuitry may also be used to receive media consumption data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 1508 is provided as a separate device from user equipment device 1500, the tuning and encoding circuitry (including multiple tuners) may be associated with storage 1508.

Control circuitry 1504 may receive instruction from a user by way of user input interface 1510. User input interface 1510 may be any suitable user interface, such as a remote control, mouse, trackball, keypad, keyboard, touch screen, touchpad, stylus input, joystick, voice recognition interface, or other user input interfaces. Display 1512 may be provided as a stand-alone device or integrated with other elements of each one of user equipment device 1500 and user equipment device 1501. For example, display 1512 may be a touchscreen or touch-sensitive display. In such circumstances, user input interface 1510 may be integrated with or combined with display 1512. In some embodiments, user input interface 1510 includes a remote-control device having one or more microphones, buttons, keypads, any other components configured to receive user input or combinations thereof. For example, user input interface 1510 may include a handheld remote-control device having an alphanumeric keypad and option buttons. In a further example, user input interface 1510 may include a handheld remote-control device having a microphone and control circuitry configured to receive and identify voice commands and transmit information to set-top box 1515.

Audio output equipment 1514 may be integrated with or combined with display 1512. Display 1512 may be one or more of a monitor, a television, a liquid crystal display (LCD) for a mobile device, amorphous silicon display, low-temperature polysilicon display, electronic ink display, electrophoretic display, active matrix display, electro-wetting display, electro-fluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. A video card or graphics card may generate the output to the display 1512. Audio output equipment 1514 may be provided as integrated with other elements of each one of device 1500 and equipment 1501 or may be stand-alone units. An audio component of videos and other content displayed on display 1512 may be played through speakers (or headphones) of audio output equipment 1514. In some embodiments, audio may be distributed to a receiver (not shown), which processes and outputs the audio via speakers of audio output equipment 1514. In some embodiments, for example, control circuitry 1504 is configured to provide audio cues to a user, or other audio feedback to a user, using speakers of audio output equipment 1514. There may be a separate microphone 1516 or audio output equipment 1514 may include a microphone configured to receive audio input such as voice commands or speech. For example, a user may speak letters or words that are received by the microphone and converted to text by control circuitry 1504. In a further example, a user may voice commands that are received by a microphone and recognized by control circuitry 1504.

Camera 1518 may be any suitable video camera integrated with the equipment or externally connected. Camera 1518 may be a digital camera comprising a charge-coupled device (CCD) and/or a complementary metal-oxide semiconductor (CMOS) image sensor. Camera 1518 may be an analog camera that converts to digital images via a video card.

The media application may be implemented using any suitable architecture. For example, it may be a stand-alone application wholly-implemented on each one of user equipment device 1500 and user equipment device 1501. In such an approach, instructions of the application may be stored locally (e.g., in storage 1508), and data for use by the application is downloaded on a periodic basis (e.g., from an out-of-band feed, from an Internet resource, or using another suitable approach). Control circuitry 1504 may retrieve instructions of the application from storage 1508 and process the instructions to provide media consumption and social network interaction functionality and generate any of the displays discussed herein. Based on the processed instructions, control circuitry 1504 may determine what action to perform when input is received from user input interface 1510. For example, movement of a cursor on a display up/down may be indicated by the processed instructions when user input interface 1510 indicates that an up/down button was selected. An application and/or any instructions for performing any of the embodiments discussed herein may be encoded on computer-readable media. Computer-readable media includes any media capable of storing data. The computer-readable media may be non-transitory including, but not limited to, volatile and non-volatile computer memory or storage devices such as a hard disk, floppy disk, USB drive, DVD, CD, media card, register memory, processor cache, Random Access Memory (RAM), etc.

Control circuitry 1504 may allow a user to provide user profile information or may automatically compile user profile information. For example, control circuitry 1504 may access and monitor network data, video data, audio data, processing data, participation data from a media application and social network profile. Control circuitry 1504 may obtain all or part of other user profiles that are related to a particular user (e.g., via social media networks), and/or obtain information about the user from other sources that control circuitry 1504 may access. As a result, a user can be provided with a unified experience across the user's different devices.

In some embodiments, the media application is a client/server-based application. Data for use by a thick or thin client implemented on each one of user equipment device 1500 and user equipment device 1501 may be retrieved on-demand by issuing requests to a server remote to each one of user equipment device 1500 and user equipment device 1501. For example, the remote server may store the instructions for the application in a storage device. The remote server may process the stored instructions using circuitry (e.g., control circuitry 1504) and generate the displays discussed above and below. The client device may receive the displays generated by the remote server and may display the content of the displays locally on device 1500. This way, the processing of the instructions is performed remotely by the server while the resulting displays (e.g., that may include text, a keyboard, or other visuals) are provided locally on device 1500. Device 1500 may receive inputs from the user via input interface 1510 and transmit those inputs to the remote server for processing and generating the corresponding displays. For example, device 1500 may transmit a communication to the remote server indicating that an up/down button was selected via input interface 1510. The remote server may process instructions in accordance with that input and generate a display of the application corresponding to the input (e.g., a display that moves a cursor up/down). The generated display may then be transmitted to device 1500 for presentation to the user.

In some embodiments, the media application may be downloaded and interpreted or otherwise run by an interpreter or virtual machine (run by control circuitry 1504). In some embodiments, the media application may be encoded in the ETV Binary Interchange Format (EBIF), received by control circuitry 1504 as part of a suitable feed, and interpreted by a user agent running on control circuitry 1504. For example, the media application may be an EBIF application. In some embodiments, the media application may be defined by a series of JAVA-based files that are received and run by a local virtual machine or other suitable middleware executed by control circuitry 1504. In some of such embodiments (e.g., those employing MPEG-2 or other digital media encoding schemes), the media application may be, for example, encoded and transmitted in an MPEG-2 object carousel with the MPEG audio and video packets of a program.

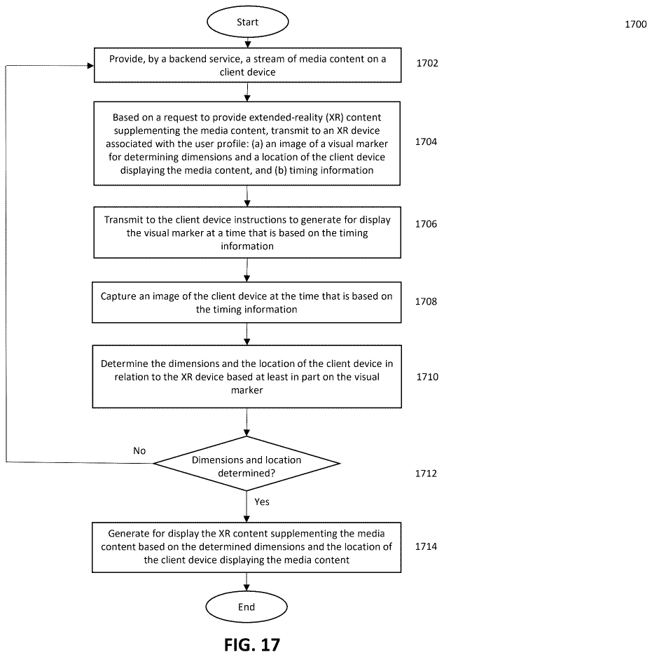

FIG. 17 is a diagram of an illustrative system 1600, in accordance with some embodiments of this disclosure. User equipment devices 1607, 1608, 1609, 1610 (e.g., user device; devices or any other suitable devices, or any combination thereof) may be coupled to communication network 1606. Communication network 1606 may be one or more networks including the Internet, a mobile phone network, mobile voice or data network (e.g., a 5G, 4G, or LTE network, or any other suitable network or any combination thereof), cable network, public switched telephone network, or other types of communication network or combinations of communication networks. Paths (e.g., depicted as arrows connecting the respective devices to the communication network 1606) may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. Communications with the client devices may be provided by one or more of these communications paths but are shown as a single path in FIG. 17 to avoid overcomplicating the drawing.

Although communications paths are not drawn between user equipment devices, these devices may communicate directly with each other via communications paths as well as other short-range, point-to-point communications paths, such as USB cables, IEEE 1394 cables, wireless paths (e.g., Bluetooth, infrared, IEEE 1602-11x, etc.), or other short-range communication via wired or wireless paths. The user equipment devices may also communicate with each other directly through an indirect path via communication network 1606.

System 1600 may comprise media content source 1602, one or more servers 1604, and one or more social network services. In some embodiments, the media application may be executed at one or more of control circuitry 1611 of server 1604 (and/or control circuitry of user equipment devices 1607, 1608, 1609, 1610.

In some embodiments, server 1604 may include control circuitry 1611 and storage 1614 (e.g., RAM, ROM, Hard Disk, Removable Disk, etc.). Instructions for the media application may be stored in storage 1614. In some embodiments, the media application, via control circuitry, may execute functions outlined in FIGS. 1-5. Storage 1614 may store one or more databases. Server 1604 may also include an input/output path 1612. I/O path 1612 may provide media consumption data, social networking data, device information, or other data, over a local area network (LAN) or wide area network (WAN), and/or other content and data to control circuitry 1611, which may include processing circuitry, and storage 1614. Control circuitry 1611 may be used to send and receive commands, requests, and other suitable data using I/O path 1612, which may comprise I/O circuitry. I/O path 1612 may connect control circuitry 1611 (and specifically control circuitry) to one or more communications paths. I/O path 1612 may comprise I/O circuitry.

Control circuitry 1611 may be based on any suitable control circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 1611 may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 1611 executes instructions for an emulation system application stored in memory (e.g., the storage 1614). Memory may be an electronic storage device provided as storage 1614 that is part of control circuitry 1611.

FIG. 17 is a flowchart of a detailed illustrative process for displaying XR content supplementing the media content based on the determined dimensions and the location of the client device displaying the media content, in accordance with some embodiments of this disclosure. In various embodiments, the individual steps of process 1700 may be implemented by one or more components of the devices and systems of FIGS. 1-16. Although the present disclosure may describe certain steps of process 1700 (and of other processes described herein) as being implemented by certain components of the devices and systems of FIGS. 1-16, this is for purposes of illustration only, and it should be understood that other components of the devices and systems of FIGS. 1-16 may implement those steps instead.

At 1702, the media server, via a control circuitry (e.g., control circuitry 1611 of FIG. 16), provides, by a backend service, a stream of media content on a client device (e.g., as shown in FIG. 1A). The backend service may be the server 1604. The client device may be a user equipment (e.g., at least one of user equipment 1607, 1608, 1609, or 1610). The backend service may provide the service utilizing an I/O path (e.g., I/O path 1612) over a communication network (e.g., communication network 1606).

At 1704, the media server, via the control circuitry, based on a request to provide XR content supplementing the media content, transmits to an XR device associated with the user profile: (a) an image of a visual marker for determining dimensions and a location of the client device displaying the media content, and (b) timing information (e.g., as shown in FIG. 1A).

The media server may transmit the image and timing information via the communication network. The media server may retrieve the image of a visual marker for determining dimensions from a data source (e.g., at least one of database 1605, storage 1614, or media content source 1602).

At 1706, the media server, via the control circuitry, transmits to the client device instructions to generate for display the visual marker at a time that is based on the timing information. The media server may transmit the instruction via the I/O path over the communication network.

At 1708, the media server, via the control circuitry, captures an image of the client device at the time that is based on the timing information. At 1710, the media server, via the control circuitry, determines the dimensions and the location of the client device in relation to the XR device based at least in part on the visual marker (e.g., as shown in FIG. 1B). If, at 1712, the media server has not determined the dimensions and the location of the client device in relation to the XR device, the process reverts to 1702. If, at 1712, the media server has determined the dimensions and the location of the client device in relation to the XR device, the process advances to 1714.

At 1714, the media server, via the control circuitry, generates for display the XR content supplementing the media content based on the determined dimensions and the location of the client device displaying the media content (e.g., as shown in FIG. 1C). The media server may transmit instructions to generate for display the XR content supplementing the media content via the I/O path over the communication network.

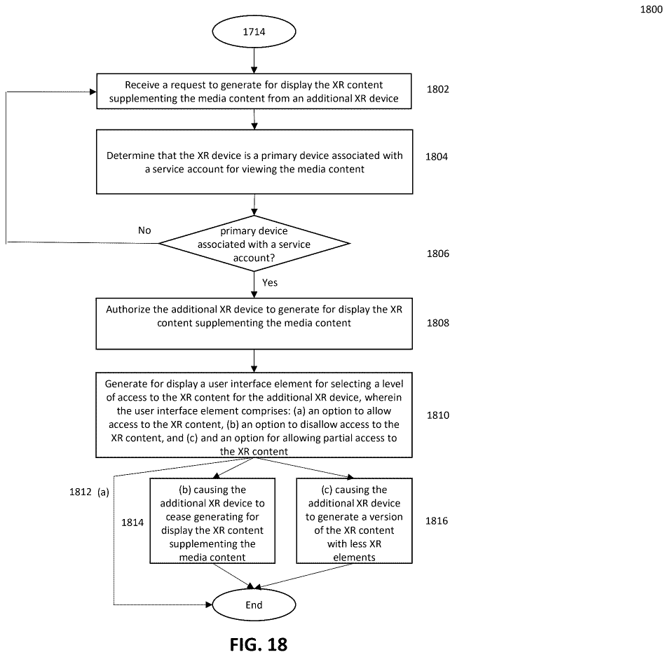

FIG. 18 is a flowchart of a detailed illustrative process 1800 for generating for display a user interface element for selecting a level of access to the XR content for the additional XR device, in accordance with some embodiments of this disclosure. At 1802, the media server, via a control circuitry (e.g., control circuitry 1611), receives a request to generate for display the XR content supplementing the media content from an additional XR device. At 1804, the media server, via the control circuitry, determines that the XR device is a primary device associated with a service account for viewing the media content. If, at 1806, the media server has determined that the primary device is not associated with the service account for viewing the media content, the process reverts to 1802. If, at 1806, the media server has determined that the primary device is associated with the service account for viewing the media content, the process advances to 1808.

At 1808, the media server, via the control circuitry, authorizes the additional XR device to generate for display the XR content supplementing the media content. At 1810, the media server, via the control circuitry, generates for display a user interface element for selecting a level of access to the XR content for the additional XR device. The user interface element comprises: (a) an option to allow access to the XR content, (b) an option to disallow access to the XR content, and (c) an option for allowing partial access to the XR content (e.g., as shown in FIG. 1C).

If, at 1814, the media server, via the control circuitry, receives a user interface selection to disallow access to the XR content, the media server causes the additional XR device to cease generating for display the XR content supplementing the media content. If, at 1816, the media server, via the control circuitry, receives a user interface selection to allow for partial XR content, the media server causes the additional XR device to generate a version of the XR content with fewer XR elements. The media server may generate a version of the XR content via an I/O path (e.g., I/O path 1612).

The processes discussed above are intended to be illustrative and not limiting. One skilled in the art would appreciate that the steps of the processes discussed herein may be omitted, modified, combined and/or rearranged, and any additional steps may be performed without departing from the scope of the invention. More generally, the above disclosure is meant to be illustrative and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
providing, by a backend service, a stream of media content on a client device;
based on a request to provide extended-reality (XR) content supplementing the media content:
transmitting to an XR device: (a) an image of a visual marker for determining dimensions and a location of the client device displaying the media content, and (b) timing information; and
transmitting to the client device instructions to generate for display the visual marker at a time that is based on the timing information;
wherein the XR device is configured to:
capture an image of the client device at the time that is based on the timing information;
determine the dimensions and the location of the client device in relation to the XR device based at least in part on the visual marker; and
generate for display the XR content supplementing the media content based on the determined dimensions and the location of the client device displaying the media content.

2. The method of claim 1, wherein the transmitting to the client device the instructions to generate for display the visual marker comprises instructions to generate the visual marker at a fixed size regardless of a size of a display of the client device.

3. The method of claim 2, further comprising:
generating simultaneous localization and mapping (SLAM) data for an environment, based at least in part on the determined dimensions and the location of the client device in relation to the XR device; and
wherein the SLAM data is further based on locations of additional objects within the environment.

4. The method of claim 3, further comprising:
transmitting the SLAM data to an additional XR device to cause the additional XR device to generate for display the XR content supplementing the media content based on the SLAM data.

5. The method of claim 3, further comprising:
based on the environment comprising a plurality of assigned seating locations, generating a respective variant of SLAM data for each of the plurality of assigned seating locations; and
based on determining that an additional XR device is associated with a particular assigned seating location, transmitting to the additional XR device a variant of SLAM data associated with the particular assigned seating location.

6. The method of claim 1, further comprising:
receiving a request to generate for display the XR content supplementing the media content from an additional XR device; and
based on determining that the XR device is a primary device associated with a service account for viewing the media content:
causing the XR device to generate for display a prompt to authorize the additional XR device;
based on an interaction with the prompt, authorizing the additional XR device to generate for display the XR content supplementing the media content; and
transmitting, to the additional XR device, instructions to generate for display the XR content supplementing the media content for the additional XR device.

7. The method of claim 6, further comprising:
generating for display a user interface element for selecting a level of access to the XR content for the additional XR device, wherein the user interface element comprises: (a) an option to allow access to the XR content, and (b) an option to disallow access to the XR content; and
based on selection of the option to disallow access to the XR content, causing the additional XR device to cease generating for display the XR content supplementing the media content.

8. The method of claim 6,
wherein the user interface element comprises: (c) an option for allowing partial access to the XR content; and
based on selection of the option allowing the partial access to the XR content, causing the additional XR device to generate a version of the XR content with fewer XR elements.

9. The method of claim 1, further comprising:
accessing metadata associated with the media content; and
generating for display the image for the visual marker, based at least in part on the metadata.

10. The method of claim 1, wherein the instructions to generate for display the visual marker comprise generating for display a plurality of visual markers that are positioned at each respective corner of a display of the client device.

11. A system comprising:
control circuitry configured to:
provide, by a backend service, a stream of media content on a client device;
based on a request to provide extended-reality (XR) content supplementing the media content:
transmit to an XR device: (a) an image of a visual marker for determining dimensions and a location of the client device displaying the media content, and (b) timing information; and
transmit to the client device instructions to generate for display the visual marker at a time that is based on the timing information;
wherein the XR device is configured to:
capture an image of the client device at the time that is based on the timing information;
determine the dimensions and the location of the client device in relation to the XR device based at least in part on the visual marker; and
generate for display the XR content supplementing the media content based on the determined dimensions and the location of the client device displaying the media content.

12. The system of claim 11, wherein the system is configured when transmitting to the client device the instructions to generate for display the visual marker, to generate the visual marker at a fixed size regardless of a size of a display of the client device.

13. The system of claim 12, wherein the system is further configured to:
generate simultaneous localization and mapping (SLAM) data for an environment, based at least in part on the determined dimensions and the location of the client device in relation to the XR device; and
wherein the SLAM data is further based on locations of additional objects within the environment.

14. The system of claim 13, wherein the system is further configured to:
transmit the SLAM data to an additional XR device to cause the additional XR device to generate for display the XR content supplementing the media content based on the SLAM data.

15. The system of claim 13, wherein the system is further configured to:
based on the environment comprising a plurality of assigned seating locations, generate a respective variant of SLAM data for each of the plurality of assigned seating locations; and
based on determining that an additional XR device is associated with a particular assigned seating location, transmit to the additional XR device a variant of SLAM data associated with the particular assigned seating location.

16. The system of claim 11, wherein the system is further configured to:
receive a request to generate for display the XR content supplementing the media content from an additional XR device; and
based on determining that the XR device is a primary device associated with a service account for viewing the media content, the system is configured to:
cause the XR device to generate for display a prompt to authorize the additional XR device;
based on an interaction with the prompt, authorize the additional XR device to generate for display the XR content supplementing the media content; and
transmit, to the additional XR device, instructions to generate for display the XR content supplementing the media content for the additional XR device.

17. The system of claim 16, wherein the system is further configured to:
generate for display a user interface element for selecting a level of access to the XR content for the additional XR device, wherein the user interface element comprises: (a) an option to allow access to the XR content, and (b) an option to disallow access to the XR content; and
based on selection of the option to disallow access to the XR content, cause the additional XR device to cease generating for display the XR content supplementing the media content.

18. The system of claim 16,
wherein the user interface element comprises: (c) an option for allowing partial access to the XR content; and
based on selection of the option allowing the partial access to the XR content, the system is configured to cause the additional XR device to generate a version of the XR content with fewer XR elements.

19. The system of claim 11, wherein the system is further configured to:
access metadata associated with the media content; and
generate for display the image for the visual marker, based at least in part on the metadata.

20. The system of claim 11, wherein the system is configured, when generating for display the visual marker, to generate for display a plurality of visual markers that are positioned at each respective corner of a display of the client device.

21-50. (canceled)
